(19) United States
(12) Patent Application Publication
(10) Pub. No.: US 2012/0086650 A1
(43) Pub. Date: Apr. 12, 2012

(54) COMPUTER-READABLE STORAGE MEDIUM HAVING STORED THEREON DISPLAY CONTROL PROGRAM, DISPLAY CONTROL SYSTEM, DISPLAY CONTROL APPARATUS, AND DISPLAY CONTROL METHOD

(75) Inventor: Ryota OIWA, Kyoto (JP)

(73) Assignee: NINTENDO CO., LTD., Kyoto (JP)

(21) Appl. No.: 13/036,198

(22) Filed: Feb. 28, 2011

(30) Foreign Application Priority Data
Oct. 6, 2010 (JP) 2010-226845

(51) Int. Cl. G06F 3/041

(52) U.S. Cl. 345/173

(57) ABSTRACT

First movement control means moves, relative to a display area of a display device, a plurality of selection objects having at least one part thereof displayed on the display area, based on an output signal outputted from an input device. Among the plurality of selection objects, when an end-located selection object reaches a predetermined position on the display area as a result of the first movement control means moving the plurality of selection objects, second movement control means moves, relative to the display area, at least one selection object displayed on the display area among the plurality of selection objects, in a direction different from a direction in which the plurality of selection objects have been moved by the first movement control means.

### CROSS REFERENCE TO RELATED APPLICATION

The disclosure of Japanese Patent Application No. 2010-226845, filed on Oct. 6, 2010, is incorporated herein by reference.

### BACKGROUND OF THE INVENTION

1. Field of the Invention

The present invention relates to a display control process conducted when displaying display-contents such as a selection object that is to be selected by a user and a content that is to be browsed by a user, and more specifically relates to a process conducted when scrolling the selection object and content.

2. Description of the Background Art

An information processing terminal for browsing contents that do not fit within one screen is conventionally known. For example, in a state where one part of a content having a size larger than a screen is displayed on the screen, a mobile phone disclosed in Japanese Laid-Open Patent Publication No. 2000-66801 enables moving the content by an operation on a numerical keypad of the mobile phone. Additionally, this mobile phone displays information indicating a position of the currently displayed content with respect to all the contents in an area outside the display area of the content. For example, a ratio of an amount of contents that have been already displayed at present to the total amount of display contents is represented as a percentage. Therefore, when the display has moved to an end of the content, the user can understand that the display has moved to an end of the content by seeing information on a percentage display.

With the mobile phone described in the Japanese Laid-Open Patent Publication No. 2000-66801, it is necessary to estimate where a content has been moved by using information displayed at an area outside the display area of the content. However, the user will be paying attention to the content when browsing the content. Therefore, in order to see the information at an area outside the display area of the content, the user will take his or her sight off the content for a moment to confirm the information at an area outside the display area of the content. As a result, if the user is performing an operation to move the content while paying attention to the content, it has been difficult for the user to intuitively understand reaching an end of the content.

### SUMMARY OF THE INVENTION

Therefore, an object of the present invention is to provide a computer-readable storage medium having stored thereon a display control program which can improve usability for a user by allowing the user to intuitively understand reaching an end of a display object such as a content and the like.

In order to achieve the above described object, the present invention has adopted the following configurations.

One aspect of the present invention is a computer-readable storage medium having stored thereon a display control program executed by a computer of a display control apparatus which displays, on a display device, a selection object selected in accordance with an operation by a user, the display control program causing the computer to operate as first movement control means and second movement control means. The first movement control means moves, relative to a display area of the display device, a plurality of selection objects having at least one part thereof displayed on the display area, based on an output signal outputted from an input device. Among the plurality of selection objects, when an end-located selection object reaches a predetermined position on the display area as a result of the first movement control means moving the plurality of selection objects, the second movement control means moves, relative to the display area, at least one selection object displayed on the display area among the plurality of selection objects, in a direction different from a direction in which the plurality of selection objects have been moved by the first movement control means.

The above described configuration allows the user to intuitively understand moving to an end of the plurality of selection objects.

In another configurational example, the second movement control means may move, among the plurality of selection objects, the end-located selection object and at least one other selection object located in the vicinity of the end-located selection object.

The above described configurational example allows the user to intuitively understand, with further ease, moving to an end of the plurality of selection objects, since more than one selection object is moved.

In still another configurational example, the second movement control means may move at least the selection objects displayed on the display area such that each of the selection objects has a different movement distance.

The above described configurational example allows the user to further intuitively understand moving to an end of the selection objects, since each of the selection objects has a different movement distance.

In still another configurational example, the second movement control means may move at least the selection objects displayed on the display area such that a selection object located closer to the end is moved for a larger distance.

The above described configurational example allows the user to further intuitively understand moving to an end the plurality of the selection objects.

In still another configurational example: the computer may be further caused to operate as movement distance determination means for determining a movement distance for which the at least one selection object is moved by the second movement control means, based on a movement velocity at which the end-located selection object is moved by the first movement control means when reaching the predetermined position on the display area; and the second movement control means may move the at least one selection object for the movement distance determined by the movement distance determination means.

The above described configurational example allows the user to intuitively understand, without a sense of discomfort, moving to an end of the plurality of selection objects, since the distance for which the selection object is moved changes in accordance with, for example, a scroll velocity on a screen.

In still another configurational example, the second movement control means may move the at least one selection object in a direction approximately perpendicular to the direction of the movement by the first movement control means.

The above described configurational example allows the user to intuitively understand moving to an end of the plurality of selection objects, since the selection object moves in a direction that is different from a movement direction of the operation by the user.

In still another configurational example, the computer may be further caused to operate as restoration means for returning the at least one selection object moved by the second movement control means to a position at which the at least one selection object has been located before the movement.

The above described configurational example allows the user to easily confirm a content of the moved selection object.

Another aspect of the present invention is a computer-readable storage medium having stored thereon a display control program executed by a computer of a display control apparatus which displays, on a display device, a selection object selected in accordance with an operation by a user, the display control program causing the computer to operate as first movement control means and second movement control means. The first movement control means moves, relative to a display area of the display device, a plurality of selection objects having at least one part thereof displayed on the display area, based on an output signal outputted from an input device. When each of the plurality of selection objects reaches a predetermined position on the display area as a result of the first movement control means moving the plurality of selection objects, the second movement control means moves, relative to the display area, a selection object that has reached the predetermined position, in a direction different from a direction in which the plurality of selection objects have been moved by the first movement control means.

The above described configuration allows the user to intuitively understand moving to an end of the plurality of selection objects.

In another configurational example: the computer may be further caused to operate as movement distance determination means for determining a movement distance for which the selection object is moved by the second movement control means, based on a movement velocity at which the selection object is moved by the first movement control means when reaching the predetermined position on the display area; and the second movement control means may move the selection object that has reached the predetermined position on the display area for the movement distance determined by the movement distance determination means.

The above described configurational example allows the user to intuitively understand both moving to an end of the plurality of selection objects and an intensity of a movement operation performed by the user, since the distance for which the selection object is moved changes in accordance with, for example, a scroll velocity on a screen.

In still another configurational example, the movement distance determination means may determine the movement distance based on the movement velocity at which the selection object is moved by the first movement control means when reaching the predetermined position on the display area, and on a parameter regarding a movement by the first movement control means in the past.

The above described configurational example allows the user to conduct a movement with the second movement control means with less sense of discomfort, since the movement distance changes not only in accordance with the movement velocity of the selection object but also with a movement of the selection object in the past.

In still another configurational example, the movement distance determination means may determine the movement distance such that the movement distance for which the selection object is moved by the second movement control means becomes larger as a distance for which the selection object has been moved in the past by the first movement control means becomes larger.

The above described configurational example allows to reduce a sense of discomfort for the user if the selection object is moved by the second movement control means even when, for example, the selection object is only moved for a small distance.

In still another configurational example: the computer may be further caused to operate as movement distance determination means for determining, when the selection object reaches the predetermined position on the display area, a movement distance for which the selection object is moved by the second movement control means, based on a distance from an endmost position of the plurality of selection objects to the selection object that has reached the predetermined position on the display area; and the second movement control means may move the selection object that has reached the predetermined position on the display area for the movement distance determined by the movement distance determination means.

The above described configurational example allows the user to intuitively understand where an end of the plurality of selection objects is, since the movement distance changes in accordance with a distance from an end of the plurality of selection objects.

In still another configurational example, the movement distance determination means may determine the movement distance such that the movement distance becomes larger as a distance from an endmost position of the plurality of selection objects to the selection object that has reached the predetermined position on the display area becomes smaller,

The above described configurational example allows the user to intuitively understand where an end of the plurality of selection objects is, since the movement by the second movement control means becomes larger for a selection object located closer to an end of the plurality of selection objects.

In still another configurational example: the computer is further caused to operate as movement distance determination means for determining a movement distance for which the selection object is moved by the second movement control means, based on a movement velocity at which the selection object is moved by the first movement control means when reaching the predetermined position on the display area, and on a distance from an endmost position of the plurality of selection objects to the selection object that has reached the predetermined position on the display area; and the second movement control means moves the selection object that has reached the predetermined position on the display area for the movement distance determined by the movement distance determination means.

The above described configurational example allows the user to intuitively understand both moving to an end of the plurality of selection objects and an intensity of a movement operation performed by the user, and allows the user to intuitively understand where an end of the plurality of selection objects is.

Another aspect of the present invention is a computer-readable storage medium having stored thereon a display control program executed by a computer of a display control apparatus which displays a content on a display device, the display control program causing the computer to operate as first movement control means and second movement control means. The first movement control means moves, relative to a display area of the display device, a plurality of contents having at least one part thereof displayed on the display area, based on an output signal outputted from an input device. When an end-located content among the plurality of contents reaches a predetermined position on the display area as a result of the first movement control means moving the plurality of contents, the second movement control means moves, relative to the display area, at least one content displayed on the display area in a direction different from a direction in which the plurality of contents have been moved by the first movement control means.

The above described configuration allows the user to intuitively understand moving to an end of the plurality of contents.

Another aspect of the present invention is a computer-readable storage medium having stored thereon a display control program executed by a computer of a display control apparatus which displays, on a display device, a movement candidate having a size that is undisplayable in a single screen, the display control program causing the computer to operate as first movement control means and second movement control means. The first movement control means moves, relative to a display area of the display device, the movement candidate having at least one part thereof displayed on the display area, based on an output signal outputted from an input device. When an end of the movement candidate reaches a predetermined position on the display area as a result of the first movement control means moving the movement candidate, the second movement control means moves the movement candidate relative to the display area in a direction different from a direction in which the movement candidate has been moved by the first movement control means.

The above described configuration allows the user to intuitively understand moving to an end of the movement candidate.

Another aspect of the present invention is a computer-readable storage medium having stored thereon a display control program executed by a computer of a display control apparatus which displays, on a display device, a list including a plurality of item objects, the display control program causing the computer to operate as first movement control means and second movement control means. The first movement control means moves, relative to a display area of the display device, the list having at least one part thereof displayed on the display area, based on an output signal outputted from an input device. When an item object located at an end of the list is moved by the first movement control means and reaches a predetermined position on the display area, the second movement control means moves at least one item object displayed on the display area among the list relative to the display area in a direction different from a direction in which the list including the plurality of item objects has been moved by the first movement control means.

The above described configuration allows the user to intuitively understand moving to an end of the list.

Another aspect of the present invention is a computer-readable storage medium having stored thereon a display control program executed by a computer of a display control apparatus which displays, on a display device, a selection object selected in accordance with an operation by a user, the display control program causing the computer to operate as first movement control means and second movement control means. The first movement control means moves, relative to a display area of the display device, a plurality of selection objects having at least one part thereof displayed on the display area, based on an output signal outputted from an input device. Among the plurality of selection objects moved by the first movement control means, when or immediately before a selection object, which is located at an end in a direction opposite of the direction of the movement by the first movement control means, reaches a predetermined position on the display area, the second movement control means moves, relative to the display area, at least the selection object located at the end in a direction different from a direction in which the plurality of selection objects have been moved by the first movement control means.

The above described configuration allows the user to intuitively understand moving to an end of the plurality of selection objects.

Another aspect of the present invention is a display control apparatus which displays, on a display device, a selection object selected in accordance with an operation by a user, the display control apparatus including a first movement control section and a second movement control section. The first movement control section moves, relative to a display area of the display device, a plurality of selection objects having at least one part thereof displayed on the display area, based on an output signal outputted from an input device. Among the plurality of selection objects, when an end-located selection object reaches a predetermined position on the display area as a result of the first movement control section moving the plurality of selection objects, the second movement control section moves, relative to the display area, at least one selection object displayed on the display area among the plurality of selection objects, in a direction different from a direction in which the plurality of selection objects have been moved by the first movement control section.

Another aspect of the present invention is a display control system which displays, on a display device, a selection object selected in accordance with an operation by a user, the display control system including a first movement control section and a second movement control section. The first movement control section moves, relative to a display area of the display device, a plurality of selection objects having at least one part thereof displayed on the display area, based on an output signal outputted from an input device. Among the plurality of selection objects, when an end-located selection object reaches a predetermined position on the display area as a result of the first movement control section moving the plurality of selection objects, the second movement control section moves, relative to the display area, at least one selection object displayed on the display area among the plurality of selection objects, in a direction different from a direction in which the plurality of selection objects have been moved by the first movement control section.

Another aspect of the present is a display control method for displaying, on a display device, a selection object selected in accordance with an operation by a user, the display control method including a first movement control step and a second movement control step. The first movement control step is a step of moving, relative to a display area of the display device, a plurality of selection objects having at least one part thereof displayed on the display area, based on an output signal outputted from an input device. The second movement control step is a step of moving, relative to the display area, in a direction different from a direction in which the plurality of selection objects have been moved at the first movement control step, when an end-located selection object among the plurality of selection objects reaches a predetermined position on the display area as a result of the first movement control step of moving the plurality of selection objects, at least one selection object displayed on the display area among the plurality of selection objects.

Each of the above described configurations allows the user to intuitively understand moving to an end of the plurality of selection objects.

In a case where the user performs an operation of moving a plurality of selection objects (for example, a scroll operation), the present invention allows the user to intuitively understand moving to an end of the plurality of selection objects.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exterior view of a game apparatus 1 according to an embodiment of the present invention;

FIG. 2 is a block diagram of the game apparatus 1 according to an embodiment of the present invention;

FIG. 3 is one example of a home screen envisioned by the present embodiment;

FIG. 4 is one example of the home screen envisioned by the present embodiment;

FIG. 5 is one example of the home screen envisioned by the present embodiment;

FIG. 6 is one example of the home screen envisioned by the present embodiment;

FIG. 7 is one example of the home screen envisioned by the present embodiment;

FIG. 8 is one example of the home screen envisioned by the present embodiment;

FIG. 9 is an illustrational figure showing a memory map of a main memory 32;

FIG. 10 is one example of a data structure of a contents icon data 325;

FIG. 11 is a flowchart showing a flow of a home menu process executed in the game apparatus 1;

FIG. 12 is a flowchart showing a flow of the home menu process executed in the game apparatus 1;

FIG. 13 is a flowchart showing a flow of the home menu process executed in the game apparatus 1;

FIG. 14 is a figure for explaining the concept of the arrangement of contents icons;

FIG. 15 is a flowchart showing details of an inertia touch-off process indicated at step S15 in FIG. 12;

FIG. 16 is a flowchart showing details of a jump representation setting process indicated at step S19 in FIG. 13;

FIG. 17 is a flowchart showing details of a jump representation process indicated at step S24 in FIG. 13;

FIG. 18 is one example of the data structure of the contents icon data 325 according to a second embodiment of the present invention;

FIG. 19 is a flowchart showing a flow of the home menu process according to the second embodiment of the present invention;

FIG. 20 is a flowchart showing a flow of the home menu process according to the second embodiment of the present invention;

FIG. 21 is a flowchart showing details of a jump amount parameter calculation process indicated at step S101 in FIG. 19;

FIG. 22 is a figure for describing the concept of a calculation of an amount of scrolling;

FIG. 23 is a flowchart showing details of an inertia scrolling process indicated at step S103 in FIG. 20;

FIG. 24 is a flowchart showing details of a jump determination process indicated at step S132 in FIG. 23; and

FIG. 25 is a flowchart showing details of a jump movement process indicated at step S133 in FIG. 23.

### DESCRIPTION OF THE PREFERRED EMBODIMENTS

Hereinafter, an embodiment of the present invention will be described with reference to the drawings. Note that the present invention is not limited to this embodiment.

First, prior to describing details of each of the embodiments, the configuration of a game apparatus used commonly in each of the embodiments will be described.

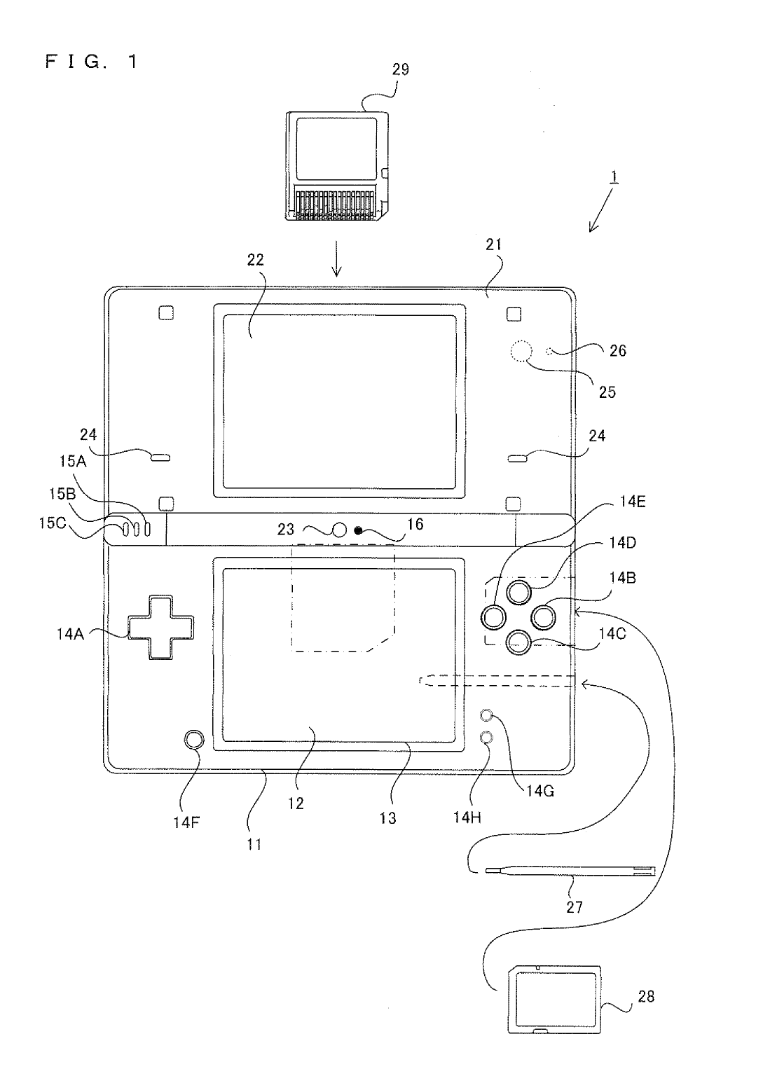

FIG. 1 is an exterior view of a game apparatus 1 for executing a home menu processing program of the present invention. Here, a hand-held game apparatus is shown as one example the game apparatus 1. In FIG. 1, the game apparatus 1 is a foldable hand-held game apparatus in an opened state. The game apparatus 1 is configured to have such a size as to be held by a user with one hand or both hands in the opened state.

The game apparatus 1 includes a lower housing 11 and an upper housing 21. The lower housing 11 and the upper housing 21 are connected to each other so as to be capable of being opened or closed (foldable). In the example of FIG. 1, the lower housing 11 and the upper housing 21 are each formed in a plate-like shape of a horizontally long rectangle, and rotatably connected to each other at long side portions thereof. Normally, the user uses the game apparatus 1 in the opened state. When not using the game apparatus 1, the user keeps the game apparatus 1 in a closed state. In the example shown in FIG 1, in addition to the closed state and the opened state, the game apparatus 1 is capable of maintaining an angle between the lower housing 11 and the upper housing 21 at any angle ranging between the closed state and the opened state by frictional force generated at a connection portion and the like. In other words, the upper housing 21 can be stationary at any angle with respect to the lower housing 11.

In the lower housing 11, a lower LCD (Liquid Crystal Display) 12 is provided. The lower LCD 12 has a horizontally long shape, and is located such that a long side thereof corresponds to a long side direction of the lower housing 11. Note that although an LCD is used as a display device built-in the game apparatus 1 in the present embodiment, any other display devices such as a display device using an EL (Electro Luminescence) and the like may be used. In addition, the game apparatus 1 can use a display device of any resolution. Although details will be described below, the lower LCD 12 is used mainly for displaying an image taken by an inner camera 23 or an outer camera 25 in real time.

In the lower housing 11, operation buttons 14A to 14K and a touch panel 13 are provided as input devices. As shown in FIG. 1, among the operation buttons 14A to 14K, the direction input button 14A, the operation button 14B, the operation button 14C, the operation button 14D, the operation button 14E, the power button 14F, the start button 14G, and the select button 14H are provided on an inner main surface of the lower housing 11 which is located inside when the upper housing 21 and the lower housing 11 are folded. The direction input button 14A is used, for example, for a selection operation and the like. The operation buttons 14B to 14E are used, for example, for a determination operation, a cancellation operation, and the like. The power button 14F is used for turning on or off the power of the game apparatus 1. In the example shown in FIG. 1, the direction input button 14A and the power button 14F are provided on the inner main surface of the lower housing 11 and on one of a left side and a right side (on the left side in FIG. 1) of the lower LCD 12 provided in the vicinity of the center of the inner main surface of the lower housing 11. Further, the operation buttons 14B to 14E, the start button 14G, and the select button 14H are provided on the inner main surface of the lower housing 11 and on the other of the left side and the right side (on the right side in FIG. 1) of the lower LCD 12. The direction input button 14A, the operation buttons 14B to 14E, the start button 14G, and the select button 14H are used for performing various operations on the game apparatus 1.

Note that the operation buttons 14I to 14K are omitted in FIG. 1. For example, the L button 14I is provided at a left end of an upper surface of the lower housing 11, and the R button 14J is provided at a right end of the upper surface of the lower housing 11. The L button 14I and the R button 14J are used, for example, for performing a photographing instruction operation (shutter operation) on the game apparatus 1. In addition, the volume button 14K is provided on a left side surface of the lower housing 11. The volume button 14K is used for adjusting volume of loudspeakers of the game apparatus 1.

The game apparatus 1 further includes the touch panel 13 as another input device in addition to the operation buttons 14A to 14K. The touch panel 13 is mounted on the lower LCD 12 so as to cover the screen of the lower LCD 12. In the present embodiment, the touch panel 13 is, for example, a resistive film type touch panel. However, the touch panel 13 is not limited to the resistive film type, but any press-type touch panel may be used. The touch panel 13 used in the present embodiment has the same resolution (detection accuracy) as that of the lower LCD 12. However, the resolution of the touch panel 13 and that of the lower LCD 12 may not necessarily be the same with each other. In a right side surface of the lower housing 11, an insertion opening (indicated by a dashed line in FIG. 1) is provided. The insertion opening is capable of accommodating a touch pen 27 which is used for performing an operation on the touch panel 13. Although an input onto the touch panel 13 is usually performed using the touch pen 27, in addition to the touch pen 27, a finger of the user can be used for operating the touch panel 13.

In the right side surface of the lower housing 11, an insertion opening (indicated by a two-dot chain line in FIG. 1) is formed for accommodating a memory card 28. Inside the insertion opening, a connector (not shown) is provided for electrically connecting the game apparatus 1 to the memory card 28. The memory card 28 is, for example, an SD (Secure Digital) memory card, and detachably mounted on the connector. The memory card 28 is used, for example, for storing an image taken by the game apparatus 1, and loading an image generated by another apparatus into the game apparatus 1.

Further, in the upper surface of the lower housing 11, an insertion opening (indicated by a chain line in FIG. 1) is formed for accommodating a cartridge 29. Inside the insertion opening, a connector (not shown) is provided for electrically connecting the game apparatus 1 to the cartridge 29. The cartridge 29 is a storage medium storing a game program and the like, and detachably mounted in the insertion opening provided in the lower housing 11.

Three LEDs 15A to 15C are mounted on a left side part of the connection portion where the lower housing 11 and the upper housing 21 are connected to each other. Three LEDs 15A to 15C are mounted on a left side part of the connection portion where the lower housing 11 and the upper housing 21 are connected to each other. The game apparatus 1 is capable of performing wireless communication with another apparatus, and the first LED 15A is lit up while the power of the game apparatus 1 is ON. The second LED 15B is lit up while the game apparatus 1 is being charged. The third LED 15C is lit up while wireless communication is established. Thus, by the three LEDs 15A to 15C, a state of ON/OFF of the power of the game apparatus 1, a state of charge of the game apparatus 1, and a state of communication establishment of the game apparatus 1 can be notified to the user.

Meanwhile, in the upper housing 21, an upper LCD 22 is provided. The upper LCD 22 has a horizontally long shape, and is located such that a long side direction thereof corresponds to a long side direction of the upper housing 21. In a similar manner to that of the lower LCD 12, a display device of another type having any resolution may be used instead of the upper LCD 22. A touch panel may be provided so as to cover the upper LCD 22. On the upper LCD 22, for example, an operation explanation screen for teaching the user roles of the operation buttons 14A to 14K and the touch panel 13 is displayed.

In the upper housing 21, two cameras (the inner camera 23 and the outer camera 25) are provided. As shown in FIG. 1, the inner camera 23 is mounted in an inner main surface in the vicinity of the connection portion of the upper housing 21. On the other hand, the outer camera 25 is mounted in a surface opposite to the surface in which the inner camera 23 is mounted, namely, in an outer main surface of the upper housing 21 (which is the surface located on the outside of the game apparatus 1 in the closed state, and the back surface of the upper housing 21 shown in FIG. 1). In FIG. 1, the outer camera 25 is indicated by a dotted line. Thus, the inner camera 23 is capable of taking an image in a direction in which the inner main surface of the upper housing 21 faces, and the outer camera 25 is capable of taking an image in a direction opposite to an imaging direction of the inner camera 23, namely, in a direction in which the outer main surface of the upper housing 21 faces. In other words, in the present embodiment, the two cameras 23 and 25 are provided such that the imaging directions thereof are opposite to each other. For example, the user can take an image of a view seen from the game apparatus 1 toward the user with the inner camera 23 as well as an image of a view seen from the game apparatus 1 in a direction opposite to the user with the outer camera 25.

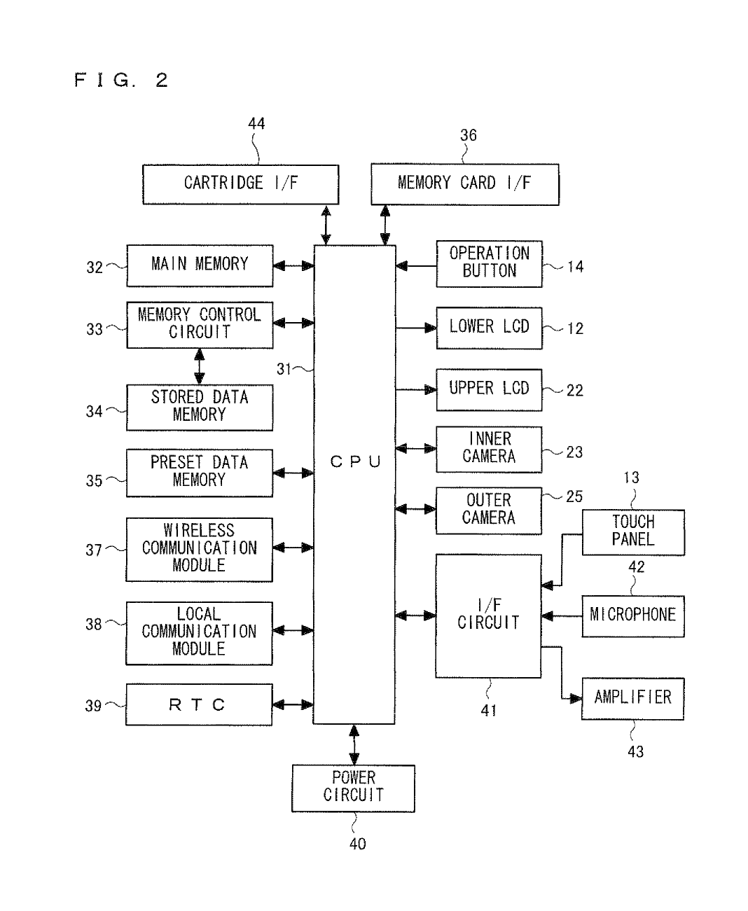

In the inner main surface in the vicinity of the connection portion, a microphone (a microphone 42 shown in FIG. 2) is accommodated as a voice input device. In the inner main surface in the vicinity of the connection portion, a microphone hole 16 is formed to allow the microphone 42 to detect sound outside the game apparatus 1. The accommodating position of the microphone 42 and the position of the microphone hole 16 are not necessarily in the connection portion. For example, the microphone 42 may be accommodated in the lower housing 11, and the microphone hole 16 may be formed in the lower housing 11 so as to correspond to the accommodating position of the microphone 42.

In the outer main surface of the upper housing 21, a fourth LED 26 (indicated by a dashed line in FIG. 1) is mounted. The fourth LED 26 is lit up at a time when photographing is performed (when the shutter button is pressed) with the outer camera 25. Further, the fourth LED 26 is lit up while a moving picture is being taken by the outer camera 25. By the fourth LED 26, it is notified to a photograph subject person and people around the subject that photographing is performed (being performed) by the game apparatus 1.

Sound holes 24 are formed in the inner main surface of the upper housing 21 and on left and right sides, respectively, of the upper LCD 22 provided in the vicinity of the center of the inner main surface of the upper housing 21. The loudspeakers are accommodated in the upper housing 21 and at the back of the sound holes 24. The sound holes 24 are for releasing sound from the speakers to the outside of the game apparatus 1 therethrough.

As described above, the inner camera 23 and the outer camera 25 which are components for taking an image, and the upper LCD 22 which is display means for displaying, for example, an operation explanation screen at the time of photographing are provided in the upper housing 21. On the other hand, the input devices for performing an operation input on the game apparatus 1 (the touch panel 13 and the buttons 14A to 14K), and the lower LCD 12 which is display means for displaying the game screen are provided in the lower housing 11. Accordingly, when using the game apparatus 1, the user can hold the lower housing 11 and perform an input on the input device while seeing a taken image (an image taken by one of the cameras) displayed on the lower LCD 12.

Next, an internal configuration of the game apparatus I will be described with reference to FIG. 2. FIG. 2 is a block diagram showing one example of the internal configuration of the game apparatus 1.

As shown in FIG. 2, the game apparatus 1 includes electronic components including a CPU 31, a main memory 32, a memory control circuit 33, a stored data memory 34, a preset data memory 35, a memory card interface (memory card I/F) 36 and a cartridge I/F 44, a wireless communication module 37, a local communication module 38, a real time clock (RTC) 39, a power circuit 40, an interface circuit (I/F circuit) 41, and the like. These electronic components are mounted on an electronic circuit substrate and accommodated in the lower housing 11 (or may be accommodated in the upper housing 21).

The CPU 31 is information processing means for executing a predetermined program. Note that, a program executed by the CPU 31 may be stored in advance in a memory within the game apparatus 1, may be obtained from the memory card 28 and/or the cartridge 29, or may be obtained from another apparatus by means of communication with said another apparatus. For example, a program may be obtained by means of download via the Internet from a predetermined server, or may be obtained by downloading a predetermined program stored in a stationary game apparatus through communication therewith.

The main memory 32, the memory control circuit 33, and the preset data memory 35 are connected to the CPU 31. The stored data memory 34 is connected to the memory control circuit 33. The main memory 32 is storage means used as a work area and a buffer area of the CPU 31. In the present embodiment, for example, a PSRAM (Pseudo-SRAM) is used as the main memory 32. The stored data memory 34 is storage means for storing a program executed by the CPU 31, data of images taken by the inner camera 23 and the outer camera 25, and the like. The stored data memory 34 is constructed of a nonvolatile storage medium, for example, a NAND flash memory, in the present embodiment. The memory control circuit 33 is a circuit for controlling reading of data from the stored data memory 34 or writing of data to the stored data memory 34 in accordance with an instruction from the CPU 31. The preset data memory 35 is storage means for storing, in the game apparatus 1, data (preset data) of various parameters and the like which are set in advance, and a later described menu processing program and the like. A flash memory connected to the CPU 31 via an SPI (Serial Peripheral Interface) bus can be used as the preset data memory 35.

The memory card I/F 36 is connected to the CPU 31. The memory card I/F 36 reads data from the memory card 28 mounted on the connector or writes data to the memory card 28 in accordance with an instruction from the CPU 31. In the present embodiment, data of images taken by the outer camera 25 is written to the memory card 28, and image data stored in the memory card 28 is read from the memory card 28 to be stored in the stored data memory 34.

The cartridge I/F 44 is connected to the CPU 31. The cartridge I/F 44 reads out data from the cartridge 29 mounted to the connector or writes data to the cartridge 29 in accordance with an instruction from the CPU 31.

The wireless communication module 37 functions to connect to a wireless LAN device, for example, by a method conformed to the standard of IEEE802.11.b/g. The local communication module 38 functions to wirelessly communicate with a game apparatus of the same type by a predetermined communication method. The wireless communication module 37 and the local communication module 38 are connected to the CPU 31. The CPU 31 is capable of receiving data from and transmitting data to another apparatus via the Internet using the wireless communication module 37, and capable of receiving data from and transmitting data to another game apparatus of the same type using the local communication module 38.

The RTC 39 and the power circuit 40 are connected to the CPU 31. The RTC 39 counts a time, and outputs the time to the CPU 31. For example, the CPU 31 is capable of calculating a current time (date) and the like based on the time counted by the RTC 39. The power circuit 40 controls electric power from a power supply (typically, a battery accommodated in the lower housing 11) of the game apparatus 1 to supply the electric power to each electronic component of the game apparatus 1.

The game apparatus 1 includes the microphone 42 and an amplifier 43. The microphone 42 and the amplifier 43 are connected to the I/F circuit 41. The microphone 42 detects voice produced by the user toward the game apparatus 1, and outputs a sound signal indicating the voice to the I/F circuit 41. The amplifier 43 amplifies the sound signal from the I/F circuit 41, and causes the speakers (not shown) to output the sound signal. The I/F circuit 41 is connected to the CPU 31.

The touch panel 13 is connected to the I/F circuit 41. The I/F circuit 41 includes a sound control circuit for controlling the microphone 42 and the amplifier 43 (the speakers), and a touch panel control circuit for controlling the touch panel 13. The sound control circuit performs A/D conversion or D/A conversion of the sound signal, and converts the sound signal into sound data in a predetermined format. The touch panel control circuit generates touch position data in a predetermined format based on a signal from the touch panel 13, and outputs the touch position data to the CPU 31. For example, the touch position data is data indicating coordinates of a position at which an input is performed on an input surface of the touch panel 13. The touch panel control circuit reads a signal from the touch panel 13 and generates touch position data every predetermined period of time. The CPU 31 is capable of recognizing a position at which an input is performed on the touch panel 13 by obtaining the touch position data.

An operation button 14 includes the above operation buttons 14A to 14K, and is connected to the CPU 31. The operation button 14 outputs operation data indicating an input state of each of the buttons 14A to 14K (whether or not each button is pressed) to the CPU 31. The CPU 31 obtains the operation data from the operation button 14, and performs processing in accordance with an input performed onto the operation button 14.

The inner camera 23 and the outer camera 25 are connected to the CPU 31. Each of the inner camera 23 and the outer camera 25 takes an image in accordance with an instruction from the CPU 31, and outputs data of the taken image to the CPU 31. In the present embodiment, the CPU 31 gives an imaging instruction to the inner camera 23 or the outer camera 25, and the camera which has received the imaging instruction takes an image and transmits image data to the CPU 31.

The lower LCD 12 and the upper LCD 22 are connected to the CPU 31. Each of the lower LCD 12 and the upper LCD 22 displays an image thereon in accordance with an instruction from the CPU 31.

(First Embodiment)

Next, a general outline of a process envisioned by a first embodiment will be described. The process of the present embodiment envisions a situation in which a scroll object such as a content and the like having a size that cannot be displayed in a single screen is browsed while being scrolled. Here the scroll object is, for example, icons and the like in menus referred to as a “home screen” or a “home menu” of a game apparatus, a personal digital assistant, and the like. Generally, a plurality of icons are aligned and displayed in such a home screen. Each of the icons corresponds to one content (application), and is a candidate that can be selected by the user (selection candidate object). For example, if a certain icon is tapped, a game process will start up. In the following description, this icon is referred to as a contents icon. Furthermore, a concept of an integration of a plurality of contents icon is referred to as a contents icon group. When the contents icon group cannot be fit into a single screen, a contents icon that is not displayed within the screen can be displayed by conducting a scroll operation.

One example of the scroll operation as described above is a so-called drag operation. For example, when one part of the contents icon group is displayed on a screen with a touch panel (the lower LCD 12 in the present embodiment), by performing a touch-on to the touch panel 13 by using the touch pen 27 and performing a slide movement with the touch pen 27 toward a predetermined direction, for example, in the right to left direction, the contents icon group can be scrolled toward the left direction. Therefore, the plurality of contents icon can be integrally scrolled in a direction parallel to an X-axis. As a result, the contents icon that is not currently displayed can be moved within the display screen (display area). Envisioned here is a case where an end of the contents icon group has been reached (a case where a contents icon located at an end of the contents icon group is displayed within the screen) by repeatedly conducting such scroll operation by the drag operation. In this case, since the end of the contents icon group has been reached, further scroll operation will be a futile operation. In such a case, in order to notify the user in an intuitive manner about reaching an end of the contents icon group, in the present embodiment, a representation process is conducted so as to have the contents icon jump as described in the following. In the following, such a representation process to notify reaching an end of the contents icon group as a result of a scroll operation is referred to as a “scroll limit representation”.

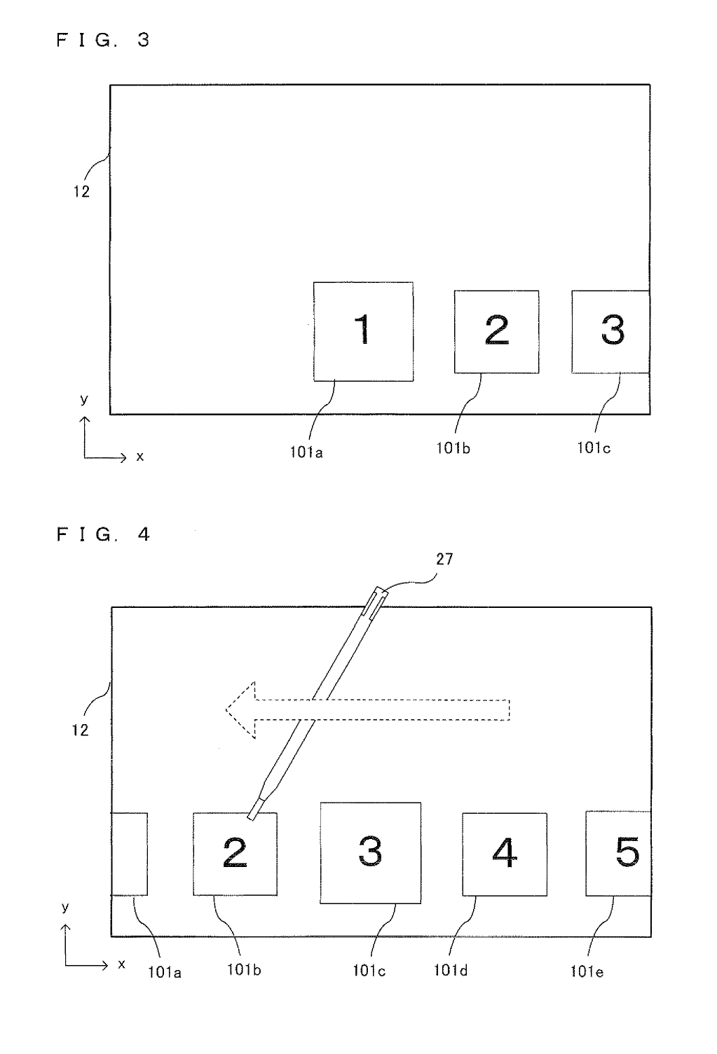

FIG. 3 is one example of a screen of the game apparatus 1 envisioned by the present embodiment. Used as an example in the present embodiment is not an operation mode in which a predetermined game starts up as soon as the power is turned on, but an operation mode in which a menu screen (hereinafter, referred to as a home screen) is displayed first. FIG. 3 shows the home screen displayed when the game apparatus 1 starts up. The home screen shown in FIG. 3 is displayed on the lower LCD 12. A plurality of contents icons 101a, 101b, and 101c (hereinafter, may be simply referred to by a generic name “contents icon”) are aligned side by side in a line and displayed on the lower LCD 12. The content icons respectively correspond to predetermined applications (for example, a camera application, an online shopping application, a game application, an application for configuring the game apparatus, and the like). By performing a tap operation on each of the icons, the user can start up an application that corresponds to a tapped icon. Here, the number of all the content icons is more than that capable of being displayed on a single screen, and the content icons are arranged side by side in a line. In the present embodiment, the description will be provided by using one example in which the number of contents icons is sixteen. Furthermore, in the following description, the first contents icon (the contents icon 101a in FIG. 3) is located at the leftmost end of the contents icon group, and a contents icon 101p, which is the sixteenth, is located at the rightmost end of the contents icon group. In addition, in the present embodiment, if a contents icon 101 located at a very end arrives at the center of the screen, further scrolling cannot be performed in a direction of this end.

In the present embodiment, the contents icon group can be scrolled in the horizontal direction by performing a drag operation or flick operation (an operation of performing a touch-on, moving a finger or the touch pen so as to lightly swipe the screen, and performing a touch-off; in other words, performing a touch-on and then an operation so as to flick) in the horizontal direction within the area in which the contents icon group is displayed. For example, assumed here is a case where a touch-on is performed on the contents icon 101b, and then a drag operation is performed toward the left direction in a state of FIG. 3. Consequently, as shown in FIG. 4, the contents icon group is displayed so as to move toward the left direction (that is, to scroll through the screen toward the left direction), resulting in a state where the contents icon 101a (the right half thereof), the contents icon 101b, the contents icon 101c, a contents icon 101d, and a contents icon 101e are displayed on the screen.

From the state shown in FIG. 3 or FIG. 4, a position within the area in which the contents icon group is displayed is touched, and a flick operation is performed toward the left direction. Then, the contents icon group will be automatically scrolled for a while, even after the touch pen 27 is removed from the touch panel 13, based on an inertia force at the time of the flick operation. The stronger a momentum of the flick operation is, the faster the scrolling is performed, and the larger the amount of scrolling is.

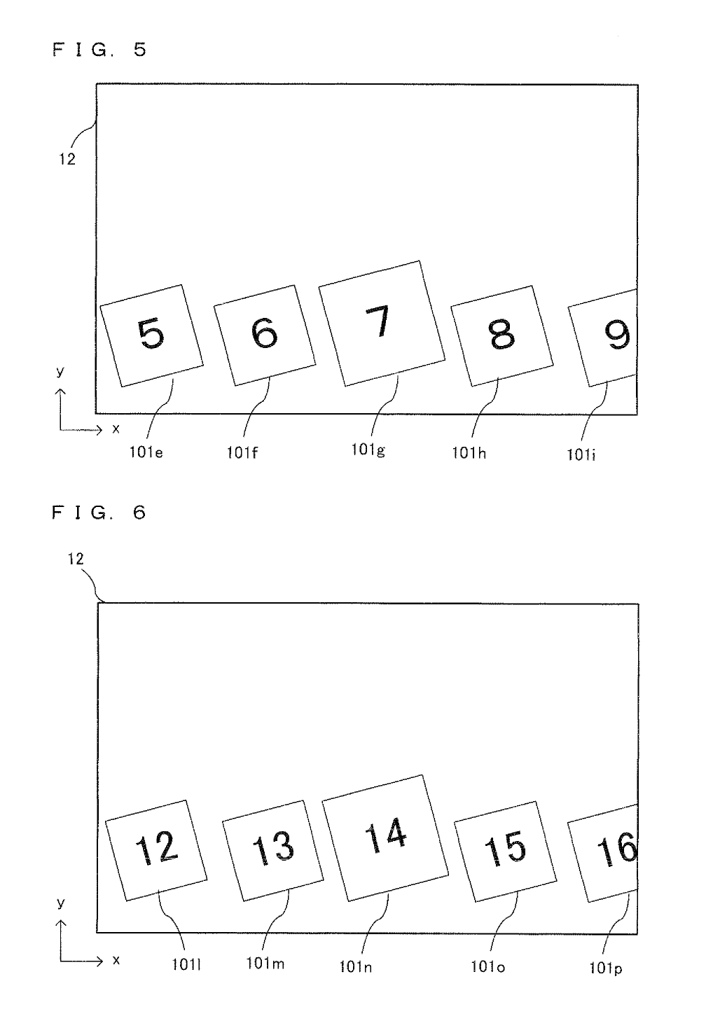

As a result of the scrolling by the above described flick operation (hereinafter, referred to as inertia scrolling), the screen goes through a state shown in FIG. 5 (this figure shows the scrolling of the contents icon group at a state where the touch pen 27 is not touching the touch panel 13, and the contents icons are respectively displayed during the scrolling in a state where they are slightly inclined toward the scrolling direction depending on a scroll velocity), and the contents icon 101p located at the rightmost end of the contents icon group enters the screen as shown in FIG. 6. Eventually the contents icon 101p arrives near the center of the screen (more precisely, the middle point of the contents icon 101p arrives at the center of the X-axis in the screen). As described above, in the present embodiment, a further scrolling cannot be performed toward the direction of the end if the endmost contents icon 101 reaches the center of the screen. For example, in the state shown in FIG. 3, even if a drag operation or a flick operation is performed toward the right direction, the contents icon 101a will not move toward the right from the center of the screen, since the contents icon 101a is already located at the center of the screen. The same is true for the contents icon 101p located at the leftmost end of the contents icon group (that is, the contents icon 101p will not move toward the left from the center of the screen even if a scroll operation is performed).

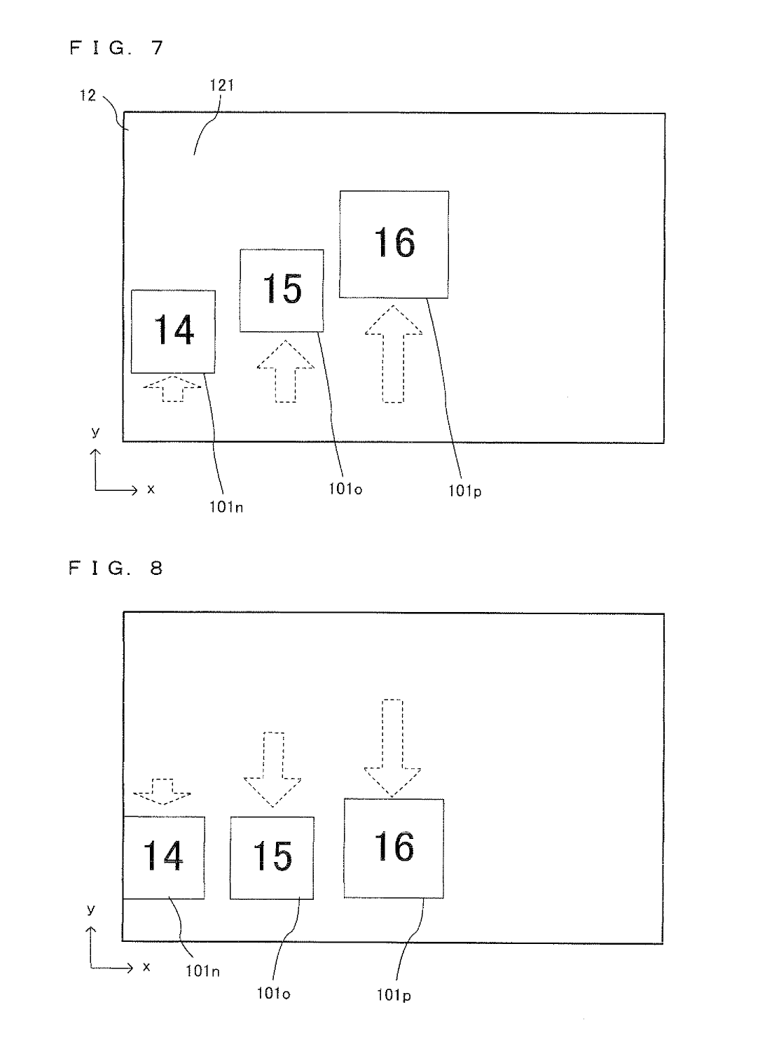

When an end of the contents icon group arrives at the center of the screen resulting from an inertia scrolling caused by a flick operation and enters a state where further scrolling cannot be conducted, in the present embodiment, a representation of having several of the contents icons 101 located near the end of the contents icon group to jump (in other words, move in a perpendicular direction of the screen, and return to the original position) is conducted, in order to notify the user in an intuitive manner regarding scrolling to an end of the contents icon group (that is, arriving at the end of the contents icon group). For example, when the contents icon 101p located at the rightmost end of the contents icon group arrives at the center of the screen, a representation of having three contents icons, a contents icon 101n, a contents icon 101o, and the contents icon 101p, to jump in the perpendicular direction is conducted as shown in FIG. 7. Here, the heights to which the three contents icons jump are respectively different, and the representation is conducted such that a contents icon located closer to an end opposite of the scrolling direction of the contents icon group will jump higher (in the example in FIG. 7, the contents icon 101p jumps the highest). As shown in FIG. 8, the contents icons return to the original positions after the jumps. Furthermore, the height of the jump also changes depending on an inertia scrolling velocity when reaching the end of the contents icon group, and the representation is conducted such that the jump will be higher if the velocity of the inertia scrolling is faster.

Furthermore, the jump representation does not end with a single jump and a landing, but an appearance of the contents icon 101 bouncing for several times is also displayed (not shown). In the following, displaying such appearance is also included when referring to the jump representation.

As described above, when an end of the contents icon group is displayed in the screen after an inertia scrolling (in the present embodiment, upon reaching the center of the screen), the present embodiment allows the user to intuitively understand scrolling to an end of the contents icon group, by conducting a representation of having several of the contents icons 101 near the end to jump. In other words, when scrolled to an end of the contents icon group, the user can intuitively recognize scrolling to an end, by moving the contents icon in a direction (in the present embodiment, the perpendicular direction, or approximately the perpendicular direction of the screen) which is different from the scrolling direction (in the present embodiment, a horizontal direction of the screen).

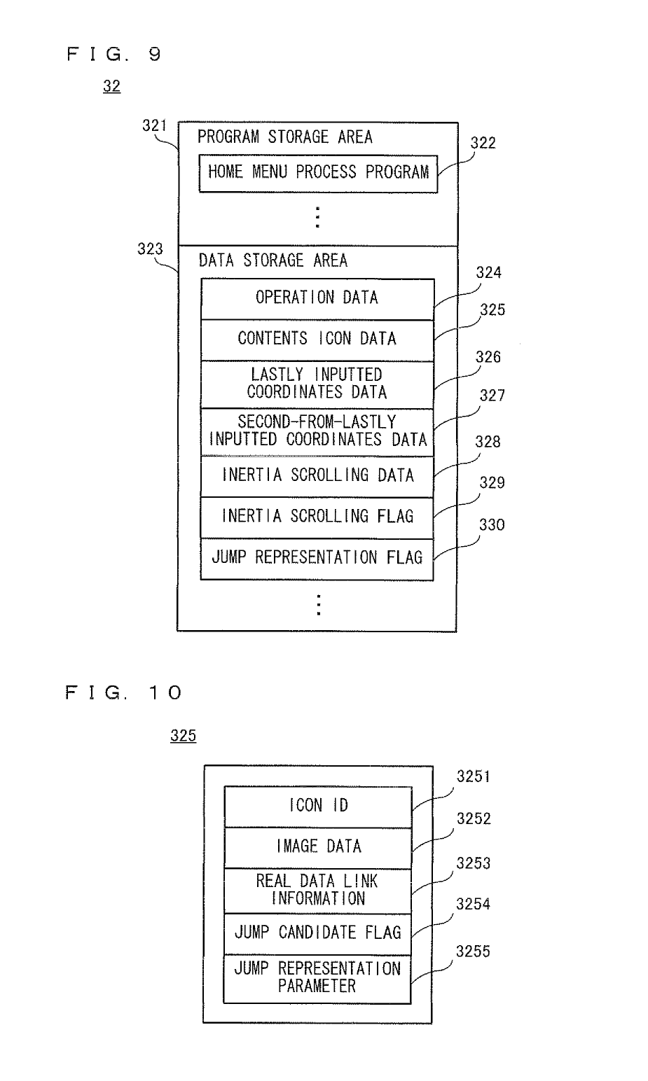

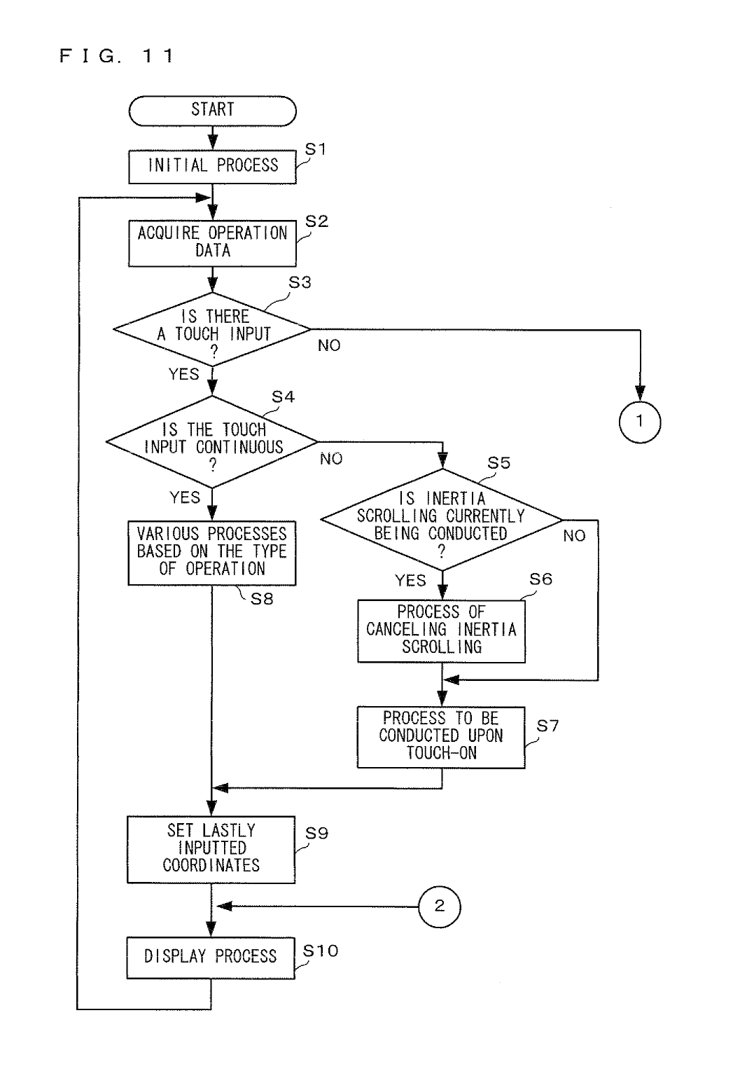

In the following, details of various data and program used in the present embodiment will be described by using FIG. 9 to FIG. 17.

FIG. 9 is an illustrational figure showing a memory map of the main memory 32 shown in FIG. 2. In FIG. 9, the main memory 32 includes a program storage area 321 and a data storage area 323. Data in the program storage area 321 and the data storage area 323 are obtained by copying, to the main memory 32, data previously stored in the preset data memory 35.

The program storage area 321 stores a home menu process program 322 and the like executed by the CPU 31.

Data such as operation data 324, contents icon data 325, lastly inputted coordinates data 326, second-from-lastly inputted coordinates data 327, inertia scrolling data 328, an inertia scrolling flag 329, a jump representation flag 330 and the like are stored in the data storage area 323.

The operation data 324 is data representing respective input states of the operation buttons 14a to 14k, and an input state of the touch panel 13. Furthermore, when there is an input to the touch panel 13, data indicating coordinates of the input is also included in the operation data 324.

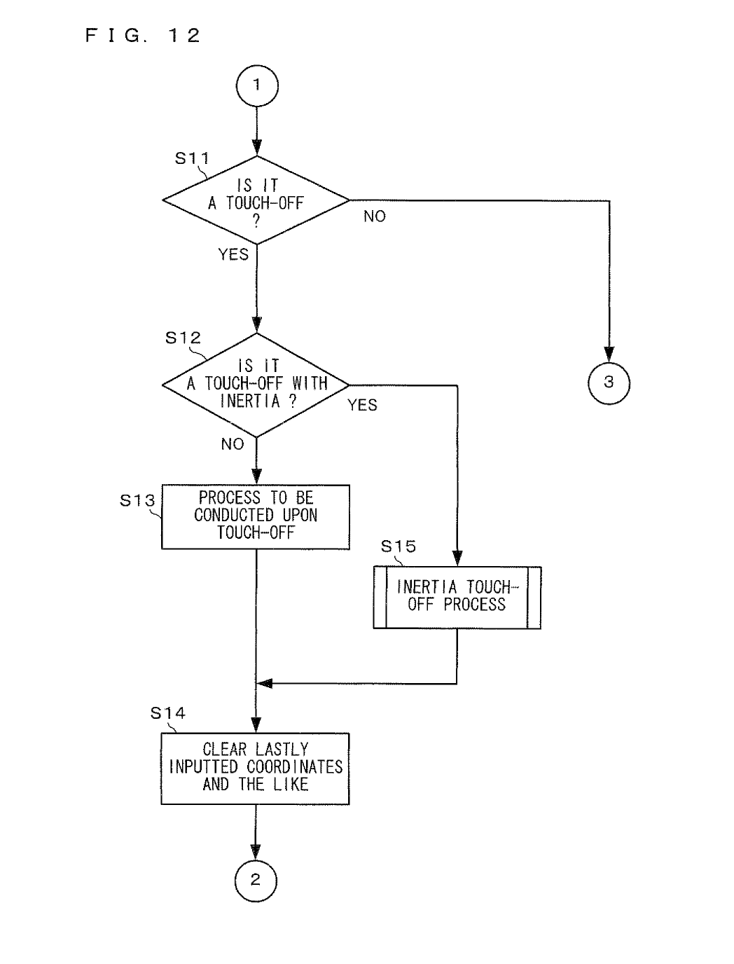

The contents icon data 325 is data representing each of the contents icons 101 displayed on the home screen. FIG. 10 is a figure showing one example of a data structure of the contents icon data 325. The contents icon data 325 includes an icon ID 3251, image data 3252, real data link information 3253, a jump candidate flag 3254, and a jump representation parameter 3255. The icon ID 3251 is an ID for uniquely identifying each of the contents icons 101. The image data 3252 is data representing an image of each of the contents icons displayed on the home screen. The real data link information 3253 is information indicating a storage location of a file which is an actual body of an application corresponding to each of the contents icons 101.

The jump candidate flag 3254 is a flag that indicates whether or not the contents icon is a candidate for the jump representation (that is, whether or not it is to be jumped), and when the jump candidate flag 3254 is set to be ON, this indicates that the contents icon is a candidate for the jump representation.

The jump representation parameter 3255 is data used when conducting the jump representation, and indicates an initial velocity of a jump, a highest reaching point of the jump, and the like for the contents icon.

Returning to FIG. 9, the lastly inputted coordinates data 326 is data indicating coordinates of an input to the touch panel in a process in an immediately preceding frame. In the process in the immediately preceding frame, if there is no input to the touch panel 13, the data will be empty, and if there is an input to the touch panel 13, the coordinates of the input is stored. Therefore, by referring to the data, a change in touch position (input coordinates) during the drag operation, and eventually the amount of movement of the touch pen 27 (which is the basis for calculating the scroll velocity) and the like can be calculated.

The second-from-lastly inputted coordinates data 327 is data indicating input coordinates acquired immediately before the lastly inputted coordinates data described above; that is, input coordinates detected in a process in a frame preceding the current frame by two frames.

The inertia scrolling data 328 is data for controlling the above described inertia scrolling; and includes an amount of scrolling per frame during an inertia scrolling, a total amount of an inertia scrolling, a decrease rate of the scroll velocity, and the like.

The inertia scrolling flag 329 is a flag for indicating whether or not an inertia scrolling is currently being conducted. If the flag is set to be ON, it indicates that an inertia scrolling is currently being conducted.

The jump representation flag 330 is a flag for indicating whether or not a process regarding representation of a jump of the contents icon 101 (jump representation) is currently being executed. If the flag is set to be ON, it indicates that a process regarding the jump representation is in the midst of being executed.

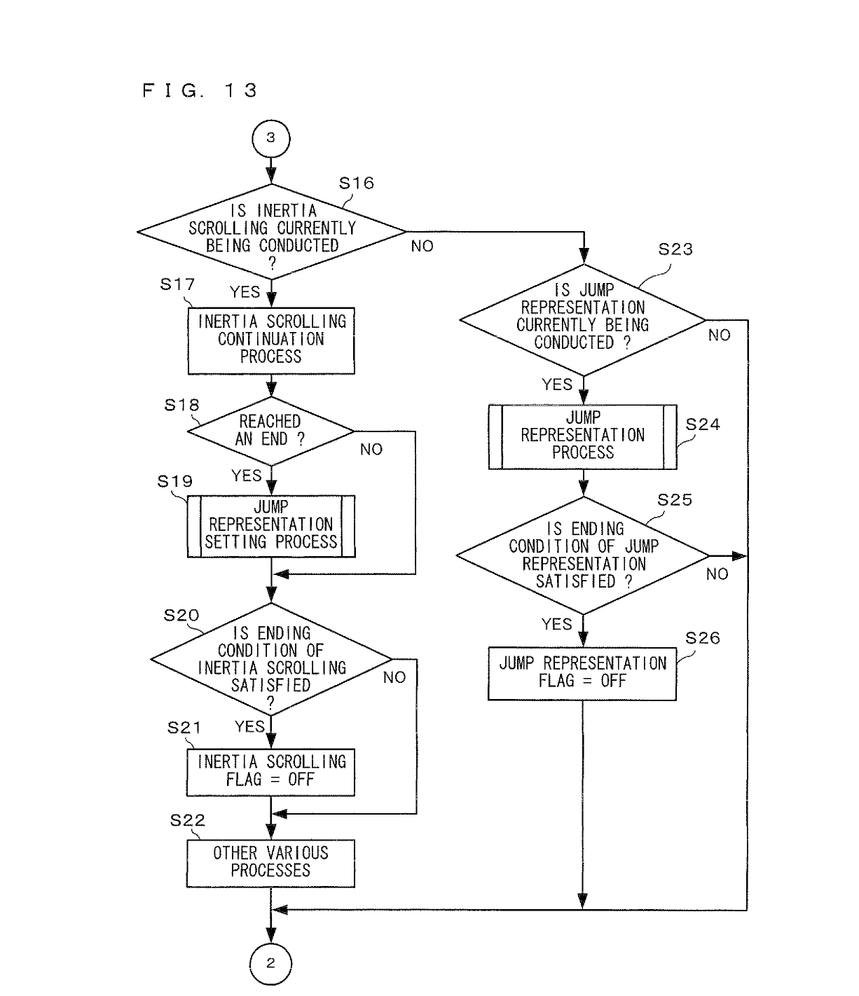

Next, a flow of a home menu process executed by the game apparatus 1 will be described by using FIG. 11 to FIG. 17. FIG. 11 to FIG. 13 are flowcharts showing flows of the home menu process executed by the game apparatus 1. When the power of the game apparatus 1 is turned on, the CPU 31 of the game apparatus 1 performs a start-up program stored in a boot ROM which is not shown, and each unit of the main memory 32 and the like are initialized. Then the home menu program stored in the preset data memory 35 is loaded into the main memory 32, and execution of the menu program is started.

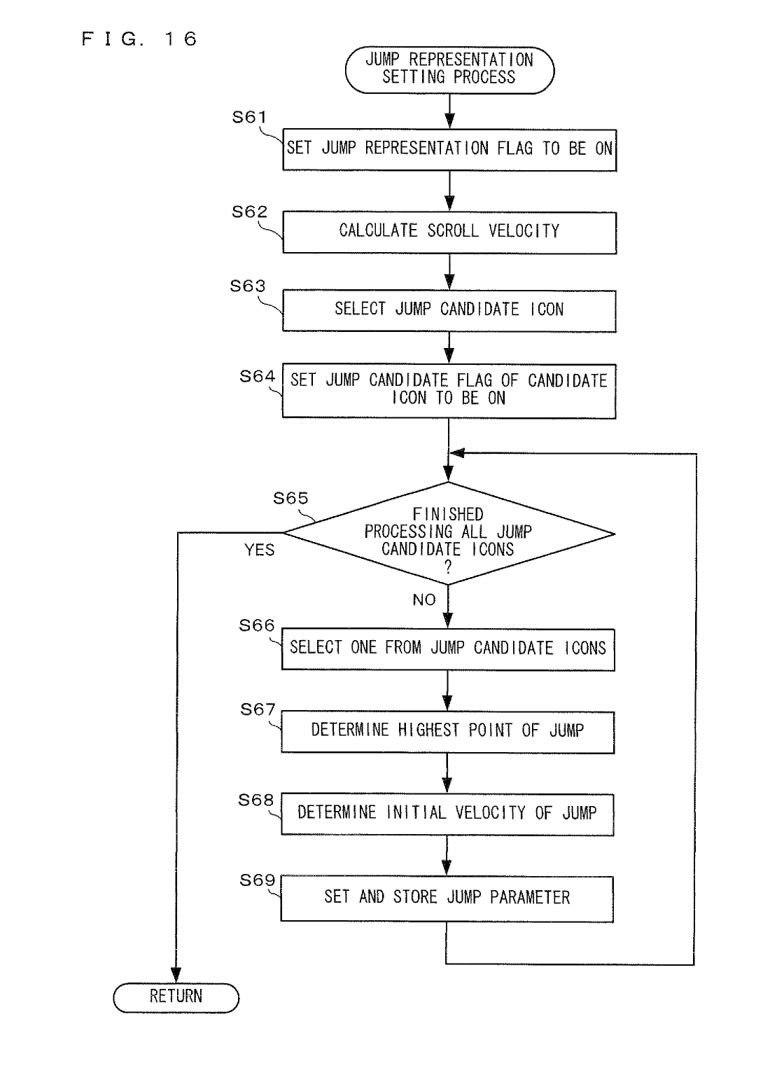

First, at step S1, an initialization process for data to be used in the following process is executed. Specifically, first, applications installed in the game apparatus are scanned, contents icons 101 corresponding respectively to the applications are generated, and a contents icon group object including the contents icons 101 is generated. Next, a contents icon group object is arranged in virtual space (refer to FIG. 14). The reason why the contents icon group object is being generated is to calculate the scroll velocity during a later described inertia scrolling, based on the amount of movement of the object. Then a virtual camera is arranged at a position where one part of the contents icons among the contents icon group is displayed, and an area (hereinafter, display area) imaged by the virtual camera is displayed on the screen. In the present embodiment, when the scroll operation as described above is conducted, scrolling of the contents icon group object is achieved by conducting a slide movement of the virtual camera (that is, the display area) on contents icon group object in accordance with the type of operation. In the following, an area imaged by the virtual camera is referred to as the display area. In such case, the amount of scrolling and the scroll velocity will be calculated based on an amount of movement and a movement velocity of the virtual camera. Note that, when the virtual camera is fixed, and the scroll operation as described above is conducted, the contents icon group object may be moved within the virtual space in accordance with the type of operation. In such case, the scroll velocity and the like will be calculated based on the amount of movement and the movement velocity of the contents icon group object. Thus, when a scroll operation as described above is performed, the contents icon group is moved relative to the display area.

Note that, the method for displaying the contents icon and the method of the scroll process described above are merely examples, and the present invention is not limited thereto, and any processing method may be used as long as displaying and scrolling of the contents icon can be conducted.

In the following, the menu process proceeds by having a process loop of steps S2 to S27 repeated in every single frame.

Next, at step S2, the operation data 324 is acquired. Then, at step S3, the acquired operation data 324 is referenced, and whether or not a touch input is performed to the touch panel 13 is determined. As a result, if it is determined that a touch input is performed (YES at step S3), a coordinate value of the input is acquired and whether or not a continuous touch input is performed is determined at the next step S4. This is determined from whether or not some data is set in the lastly inputted coordinates data 326. As a result of the determination, if it is determined that a continuous touch input is NOT performed (NO at step S4), this means an operation categorized as the so-called touch-on is performed. In this case, first, at step S5, it is determined whether or not an inertia scrolling is currently being conducted; that is, determined whether or not it is still in a state in which the inertia scrolling by the flick operation as described above is still continuing. As a result, if it is determined that the inertia scrolling is currently being conducted (YES at step S5), a process of cancelling the inertia scrolling, that is, a process to stop the scrolling, is executed at step S6. At this moment, the inertia scrolling flag 329 is set to be OFF. On the other hand, if it is determined that the inertia scrolling is NOT currently being conducted (NO at step S5), the process at step S6 is skipped.

Next, at step S7, a process to be conducted upon the touch-on is executed. In this process, a predetermined process in accordance with the input coordinates described above is executed as appropriate. For example, when the content icons 101 are touched-on, a process for displaying a description of an application corresponding to the content icons 101, or the like is executed. Then, the process is advanced to step S9, which is described later.

On the other hand, as a result of the determination at step S4 described above, if it is determined that a continuous touch input is performed (YES at step S4), the possibility is either a state in which an identical position is continuously being touched, or a drag operation (scroll operation) is being performed. In either case, next, at step S8, various processes based on the type of operation are executed as appropriate. For example, if the type of operation is a drag operation in a horizontal direction, the contents icon group is scrolled to the horizontal direction in accordance with an amount of change and change direction of the input coordinates (more precisely, scrolling of the contents icon group is achieved by moving the display area described above in accordance with the amount of change and change direction).

Next, at step S9, setting of the lastly inputted coordinates data 326 is conducted. Specifically, first, a content of the lastly inputted coordinates data 326 is stored in the main memory 32 as the second-from-lastly inputted coordinates data 327. Furthermore, the input coordinates of a touch position included in the operation data acquired at step S2 described above is stored in the main memory 32 as the lastly inputted coordinates data 326. Next, at step S10, a display process is conducted. More specifically, an image reflecting the above described process is generated, and a process of displaying the image on the lower LCD 12 is executed. Then, the process returns to the above described step S2, and the processes are repeated.

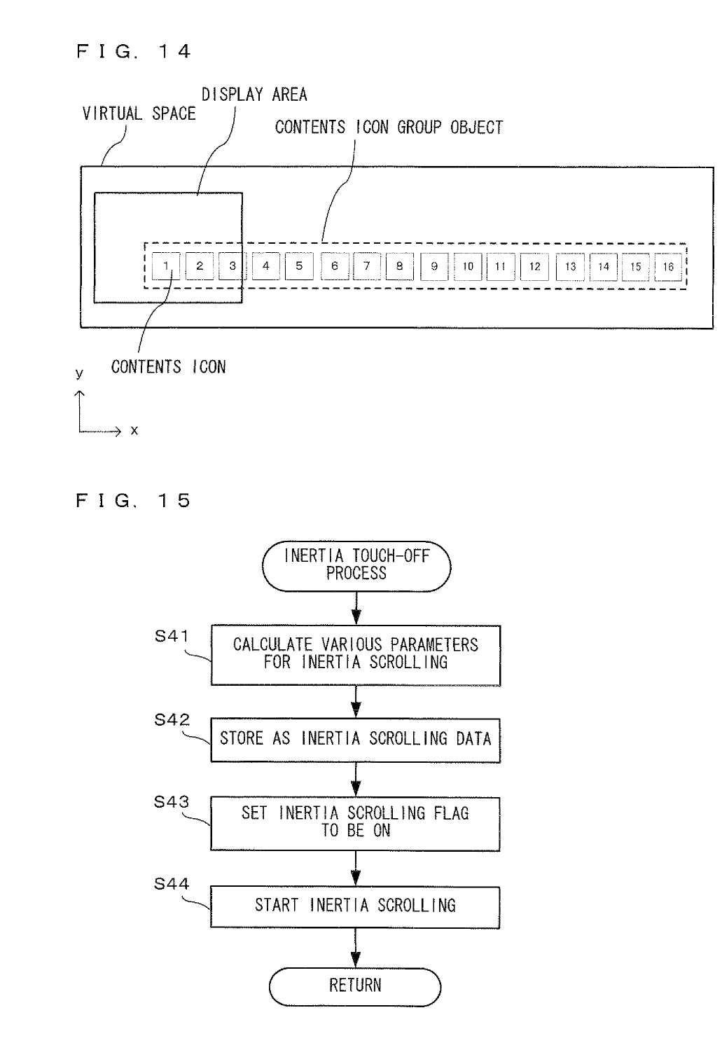

Described next is the process conducted when it is determined, as a result of the determination at step S3 described above, that a touch input is NOT performed (NO at step S3). In this case, first, at step S11 in FIG. 12, it is determined whether or not the current operation state is a touch-off. Specifically, the lastly inputted coordinates data 326 is referenced, and if some data is stored therein, the current operation state is determined as a touch-off, and if the lastly inputted coordinates data 326 is empty, the current operation state is determined as not being a touch-off (thus a state of not being touched has been continuing). As a result of the determination, if the current operation state is determined as a touch-off (YES at step S11), next, at step S12, it is determined whether or not the touch-off is one with inertia resulting from a flick operation as described above. This is determined from whether or not the amount of change of input coordinates, which is indicated from the lastly inputted coordinates data 326 and the second-from-lastly inputted coordinates data 327, is equal to or larger than a predetermined value. If the amount of change is at a certain level, it is determined that a flick operation as described above is performed and that the touch-off with inertia is generated.

As a result of the determination at step S12, if it is determined that the touch-off with inertia is performed (YES at step S12), next, at step S15, an inertia touch-off process is executed. This process is a process for conducting the inertia scrolling as described above.

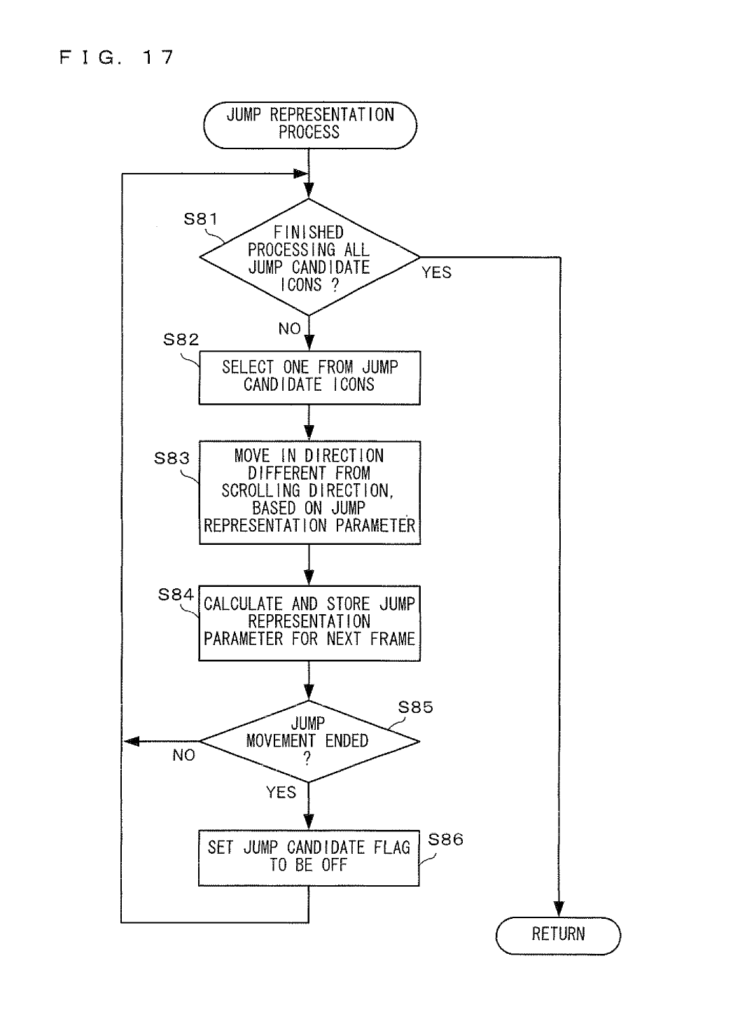

FIG. 15 is a flowchart showing details of the inertia touch-off process indicated at step S22 described above. In FIG. 15, first, at step S41, various parameters for conducting the inertia scrolling are calculated. For example, an amount of the scrolling, a velocity of the scrolling, a duration of the scrolling, and the like are calculated in accordance with the amount of change of the input coordinates indicated by the above described lastly inputted coordinates data 326 and second-from-lastly inputted coordinates data 327. Then, at step S42, the calculated parameters are stored in the main memory 32 as the inertia scrolling data 328.

Next, at step S43, the inertia scrolling flag 329 is set to be ON. At the following step S44, an inertia scrolling is initiated based on the inertia scrolling data 328. Then, when a touch-off is performed by a flick operation, the above described inertia scrolling is displayed. With this, the inertia touch-off process ends.

Returning to FIG. 12, when the process at step S15 ends, the process is advanced to step S14, which is described later.

On the other hand, as a result of the determination at step S12 described above, if it is determined that the touch-off with inertia is NOT performed (that is, a normal touch-off without the flick operation is performed) (NO at step S12); next, at step S13, various processes to be conducted upon a touch-off are executed. For example, if a touch-off performed in a state where a contents icon 101 has been touched (that is, if a tap operation is performed on the contents icon 101), a process and the like for starting up an application corresponding to the contents icon 101 that has been touched is executed. Note that, when any application starts up, the home menu process stops for a moment but restarts when the application is ended.

Next, at step S14, associated with the touch-off operation, the lastly inputted coordinates data 326 and the second-from-lastly inputted coordinates data 327 are cleared. Then, the process is advanced to step S10, which is described above.

Described next is the process conducted when it is determined as NOT being a touch-off as a result of the determination at step S11 described above (NO at step S11). In this case, it can be assumed that a state where the user is not touching the touch panel is continuing. In such case, first, at step S16 in FIG. 13, the inertia scrolling flag 329 is referenced, and it is determined whether or not an inertia scrolling is currently being conducted. As a result, if it is determined that an inertia scrolling is NOT currently being conducted (NO at step S16), the process is advanced to step S23, which is described later.

On the other hand, if it is determined that an inertia scrolling is currently being conducted (YES at step S16), next, at step S17, the process of the inertia scrolling based on the inertia scrolling data 328 is continued.

Next, at step S18, whether or not an end of the contents icon group has been reach as a result of the continuation of the inertia scrolling is determined. For example, it is determined whether the middle point of a contents icon located at the right end or the left end of the contents icon group has arrived at the center of the screen. As a result of the determination, if it is determined that an end has NOT been reached (NO at step S18), the process is advanced to step S20, which is described later.

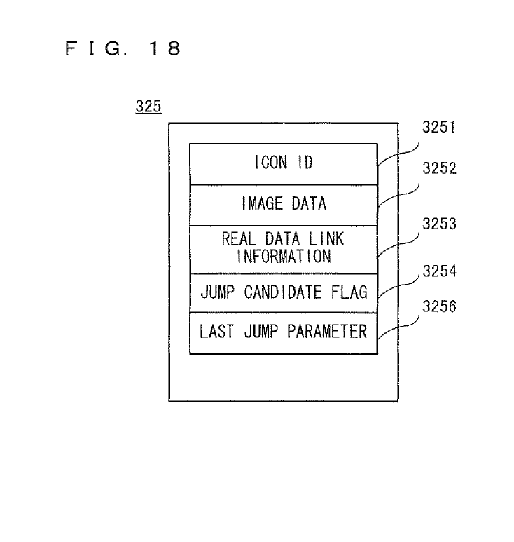

On the other hand, if an end has been reached (YES at step S18), at step S19, a jump representation setting process is executed. FIG. 16 is a flowchart showing details of the jump representation setting process indicated at step S19. In FIG. 16, first, at step S61, the jump candidate flag 3254 is set to be ON. Next, at step S62, calculation of the scroll velocity at this point in time is conducted. This is achieved by determining a position on an X-axis for the contents icon group object (position in an X-axis of a local coordinate system for the contents icon group object), at the central coordinate position on another X-axis in the display area (center of the X-axis of a coordinate system for the display area), and then calculating the scroll velocity based on the amount of change of the position from the last frame to the present frame. Thus, the scroll velocity is calculated based on the amount of movement of the virtual camera from the last frame to the present frame (or the amount of movement of the contents icon group object). For example, if the contents icon 101 located (displayed) at the central portion in the display area is the third from the left end in the last frame and the fourth from the left end in the present frame in one case, and if it is the third from the left end in the last frame and the sixth from the left end in the present frame in another case; the latter case has a faster scroll velocity.

Note that, the calculation of the scroll velocity is not limited to the method described above, and the scroll velocity may be calculated based on the amount of movement of the virtual camera (or the contents icon group object) through several past frames. Any other method may be used if it can calculate the scroll velocity.

Next, at step S63, a contents icon 101 which becomes a candidate for conducting the jump representation as described above is selected (hereinafter, referred to as a jump candidate icon). In the present embodiment, three contents icons 101 from an end are selected as jump candidates.

Next, at step S64, the jump candidate flags 3254 of the selected jump candidate icons are set to be ON.

Next, at step S65, for all the jump candidate icons (the contents icon which have had their jump candidate flags 3254 set to be ON), it is determine whether or not a setting process for the jump representation as described in the following has been executed. As a result, if there is one or more unprocessed jump candidate icons remaining (NO at step S65), at step S66, one of the unprocessed jump candidate icons is selected. Next, at step S67, a highest reaching point of a jump (height of a jump) is determined based on a sequential order of the selected jump candidate icon from an end of the contents icon group. In the present embodiment, as described above, one that is located closer to an end of the contents icon group is set to jump higher.

Next, at step S68, an initial velocity of the jump of the jump candidate icon is determined based on the highest reaching point of the jump and the calculated scroll velocity. Furthermore, at step S69, the highest reaching point of the jump and the jump initial velocity are stored as the jump representation parameters 3255. In addition, other than such parameters, parameters such as an amount of jump and the like necessary for displaying the jump are determined as appropriate and stored. Then the process returns to step S65 described above.

On the other hand, as a result of the determination at step S65 described above, if it is determined for all the jump candidate icons that the above described setting process have been completed (YES at step S65), the jump representation setting process ends.

Returning to FIG. 13, when the jump representation setting process at step S19 ends, next, at step S20, it is determined whether or not an ending condition of the inertia scrolling is satisfied. For example, depending on whether or not the inertia scrolling has reached the amount of inertia scrolling represented by the inertia scrolling data 328, whether or not the inertia scrolling should be ended is determined. Additionally in the determination, the ending condition is determined to be satisfied also when it has been determined that an end has been reached at step S18. As a result of the determination at step S20, if it is determined that the ending condition of the inertia scrolling is NOT satisfied (NO at step S20), the process is advanced to step S22 described later. On the other hand, if it is determined that the ending condition of the inertia scrolling is satisfied (YES at step S20), at step S21, the inertia scrolling flag 329 is set to be OFF.

Next, at step S22, various processes for those other than the above described inertia scrolling are executed as appropriate. Descriptions of these processes are omitted since they are not directly related to the present embodiment. Then, the process is advanced to step S10, which is described above.

Described next is a process conducted when it is determined that an inertia scrolling is currently NOT being conducted (NO at step S16) as a result of the determination at step S16. In this case, it is determined whether or not a jump representation is currently being conducted by referencing the jump representation flag 330 at step S23. Thus, when reaching an end of the contents icon group due to the inertia scrolling as described above, it is determined whether or not the process for the jump representation is continuing after the end of the inertia scrolling itself (this is because, even after the discontinuation of the inertia scrolling, jumping and bouncing of the contents icon 101 for several of times are displayed in several to several tens of frames). As a result of the determination, if it is determined that a jump representation is NOT currently being conducted (NO at step S23), the process returns to step S10, and the processes are repeated. On the other hand, if it is determined that a jump representation is currently being conducted (YES at step S23), at step 524, a jump representation process is executed.

FIG. 17 is a flowchart showing details of the jump representation process indicated at step S24 described above. In FIG. 17, first, at step S81, it is determined whether or not a jump representation process as described in the following has been executed for all the jump candidate icons. As a result of the determination, if it is determined that there is one or more unprocessed jump candidate icons remaining (NO at step S81), at step S82, one of the unprocessed jump candidate icons is selected.

Next, at step S83, based on the jump representation parameter 3255, a process to have the jump candidate icon to jump is executed (among a series of movement processes involved in a jump, a process for conducting a movement in the present frame, including the bouncing movement described above). Thus, a process of moving the jump candidate icon in a direction different from the scrolling direction is executed (in the present embodiment, a direction perpendicular to the scrolling direction). In the following description, a series of movements of the contents icon related to the jump representation is referred to as a “jump movement”.

Next, at step S84, a process of calculating and, if necessary, updating the jump representation parameter 3255 is executed, such that it can be used in a process loop in the next frame. For example, when a jump has reached a highest point in the present frame, in the next frame, it is necessary to display a descent of the jump candidate icon. Therefore, a velocity in the minus direction, which is a negative value, is calculated, and stored in the jump representation parameter 3255. Furthermore, in order to display the appearance of bouncing as described above, when the jump candidate icon lands, the velocity in the minus direction (descent velocity) is added to the jump initial velocity to recalculate a new jump initial velocity.

Next, at step S85, it is determined whether or not the jump movement of the jump candidate icon has ended. This is achieved by, for example, determining whether or not the jump initial velocity has become equal to or less a predetermined value, or determining whether or not the jump initial velocity has become zero. As a result of the determination, if it is determined that the jump movement of the jump candidate icon has not been ended (NO at step S85), the jump candidate icon is regarded as being processed and the process returns to step S81, and the above described processes will be repeated for an unprocessed jump candidate icon. On the other hand, if it is determined that the jump movement has been ended (YES at step S85), at step S86, the jump candidate flag 3254 of the jump candidate icon is set to be OFF. Then, the process returns to step S81 and the above described processes are repeated.

On the other hand, as a result of the determination at step S81, if it is determined that the processes related to the jump representation as described above have been ended for all the jump candidate icons (YES at step S81), the jump representation process ends.

Returning to FIG. 13, if the jump representation process at step S24 ends, next, at step S25, it is determined whether or not an ending condition of the jump representation is satisfied. This is determined by whether or not there is a contents icon having the jump candidate flag 3254 that is set to be ON. As a result of the determination, if it is determined that the ending condition of the jump representation is not satisfied (NO at step S25), the process returns to step S10. On the other hand, if it is determined that the ending condition of the jump representation is satisfied (YES at step S25), at step S26, the jump representation flag 330 is set to be OFF. Then the process returns to step S10.

This concludes the descriptions of the home menu process according to the first embodiment.

As described above, in the first embodiment, the contents icon 101 is moved in a direction different from the scrolling direction when an end of the contents icon group arrives at the predetermined position in the display area as a result of the inertia scrolling. This allows the user to intuitively understand scrolling to an end of the contents icon group, without the need of narrowing the area in which the contents are displayed. In addition, the height of a jump is set such that a faster scrolling velocity results in a higher jump. Furthermore, a contents icon that is closer to an end side of the contents object group will jump higher. These also allow the user to intuitively recognize scrolling to an end.

(Second Embodiment)

Next, processes of a game apparatus according to the second embodiment of the present invention will be described. A block diagram showing the hardware configuration of this game apparatus is similar to that of the first embodiment (refer to FIG. 1 and FIG. 2). However, in the present embodiment, a program that is partly different from that of the first embodiment is stored in the main memory 32, and a function similar to that of the first embodiment is achieved by having the CPU 31 execute the program.

Next, a general outline of a home menu process according to the second embodiment will be described. In the first embodiment, whether or not an end of the contents icon group has arrived at the predetermined position in the display area resulting from the inertia scrolling is determined, and the representation process of jumping is conducted as appropriate in accordance with the determination. In the processes according to the second embodiment, the function similar to that of the first embodiment is achieved without conducting the determination of “whether or not an end of the contents icon group has arrived at the predetermined position in the display area”. Namely, in the second embodiment, a process related to the jump representation is conducted every time any one of the contents icons is located at the center of the display area. However, the height of a jump is set depending on a distance of a contents icon from an end of the contents icon group. In the present embodiment, a height of the jump is set such that a contents icon group located closer to an end jumps higher. As a result, when a contents icon located near the middle of the contents icon group passes through the center of the display area, the processes related to the jump representation is conducted but the height of the jump is set to be zero, thus the contents icon does not actually jump. On the other hand, when a contents icon located at an end of the contents icon group arrives at the center of the display area (that is, scrolling to an end), the height of the jump is set at a certain height, and the jump representation is conducted such that the icon located at the end jumps.

Next, various data used in the second embodiment will be described. Basically, data similar to the data in the first embodiment is used, however, the structure of the contents icon data 325 is slightly different from that in the first embodiment.

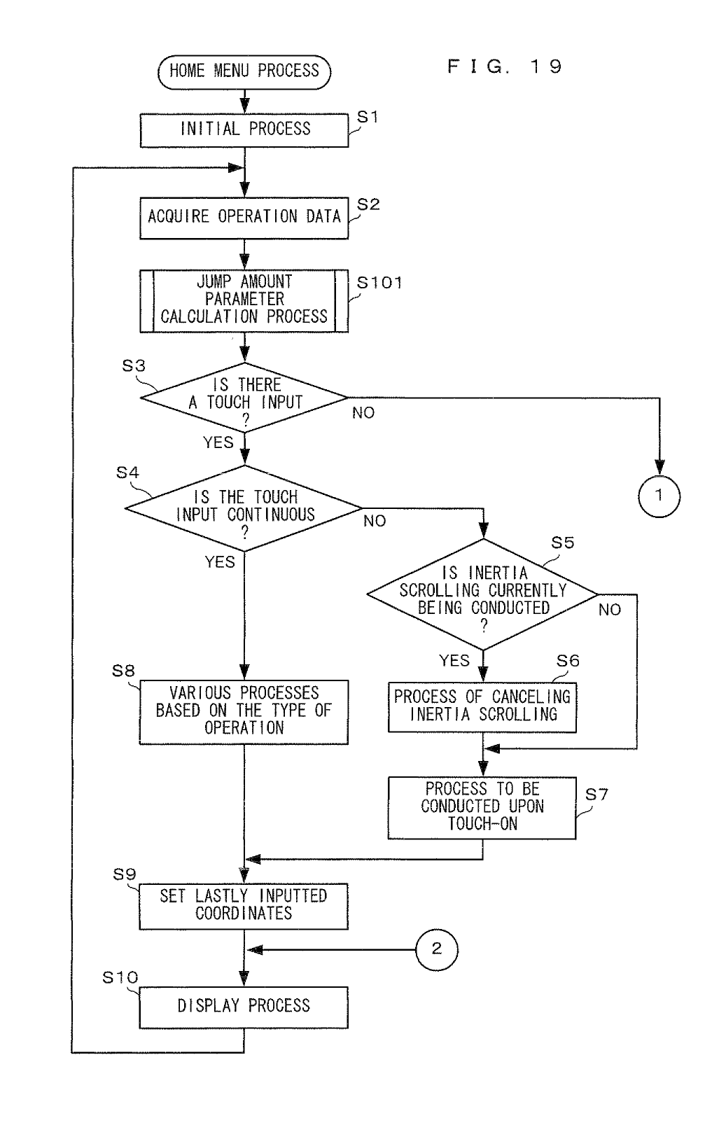

FIG. 18 is an illustrational figure showing the data structure of a contents icon data according to the second embodiment. With regard to various data shown in FIG. 18, instead of the jump representation parameter 3255, a last jump parameter 3256 is included in the contents icon data 325 of the first embodiment, which is described above by using FIG. 10. Stored in the last jump parameter 3256 is a jump representation parameter used in the jump representation in an immediately preceding frame.

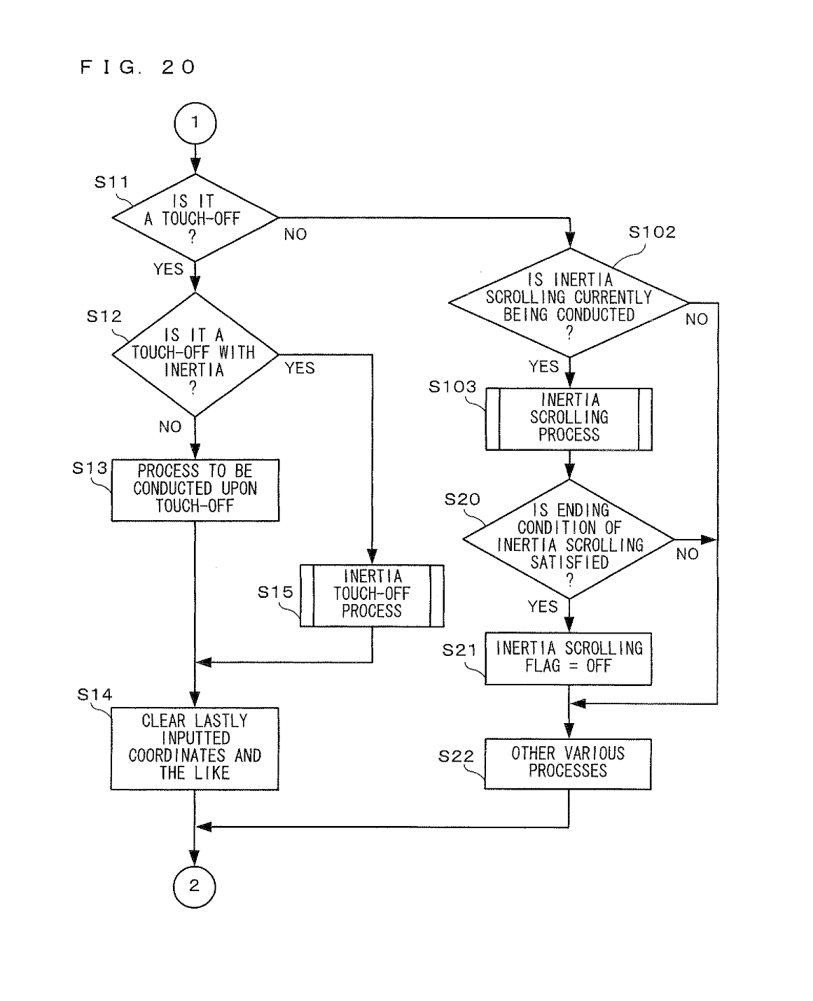

Next, a flow of the home menu process according to the second embodiment will be described by using FIG. 19 and FIG. 20. Note that, the processes at steps S1 to S15 and S20 to S22 in these flowcharts are identical to those in the flowcharts shown in FIG. 11 to FIG. 13, and an identical reference character is given to steps that are identical. Differences from the first embodiment include a point where a process at step S101 is conducted after step S2, and a difference in a flow of the processes when determined NO at the determination at step S11. Descriptions centered in the differences from the first embodiment will be provided in the following.

In FIG. 19, when an operation data is acquired at step S2, next at step S101, a jump amount parameter calculation process is executed. This process is a process of calculating a parameter for determining an amount of jump of the contents icon based on an amount of scrolling (scroll velocity). In other words, this is a process that determines the height of the jump of the contents icon in accordance with a scroll velocity when the contents icon 101 passes through the center of the display area.

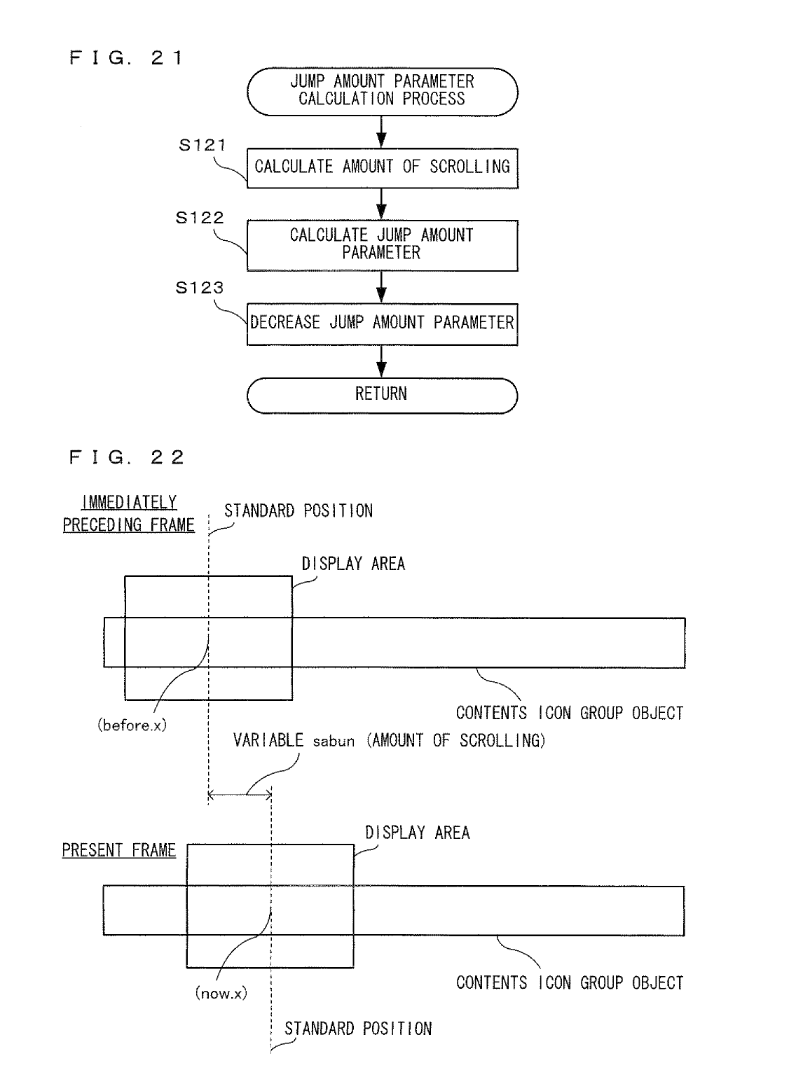

FIG. 21 is a flowchart showing details of the jump amount parameter calculation process indicated at step S101. First, at step S121, a variable “sabun” indicating an amount of scrolling from an immediately preceding frame to the present frame is calculated. This is calculated, for example, by using the following formula.

sabun=(now.x)−(before.x) Formula 1

For example, when a central point of the display area is defined as a standard position, here, a variable (now.x) indicates a position in the X-axis of the contents icon group object displayed in the standard position in the present frame. Furthermore, a variable (before.x) indicates a position in the X-axis of the contents icon group object displayed in the standard position in the immediately preceding frame. An amount of movement of the contents icon group object at the standard position is calculated as the variable sabun, more specifically, as the amount of scrolling (refer to FIG. 22).

Next, at step S122, the jump amount parameter is calculated by using the following formula.

tmpV=(Coefficient a×tmpV)+(Coefficient b×sabun) Formula 2

Here, coefficient a and coefficient b are coefficients for assigning weights to respective variables. In this case, coefficient a is 0.9 and coefficient b is 0.1. The jump amount parameter is set to be zero in the initialization process at step S1. By using the above described formula, the larger the amount of scrolling (accumulation of velocity in every frame) up to the present time is, a larger value is calculated as the jump amount parameter. Furthermore, the larger a change in the amount of scrolling is, in other words, the faster the scroll velocity is, a larger value is calculated as the jump amount parameter. By conducting such a calculation in every frame, it is possible to prevent the contents icon 101 from jumping by even a slight operation by the user due to an excessive sensitivity in responding to a user operation.

Next, at step S123, the jump amount parameter is decreased by using the following formula.

tmpV=tmpV×0.9 Formula 3

Since this process is repeatedly executed in every frame, if a period in which a user operation is not performed continues, tmpV will become zero at the end.

With this, the jump amount parameter calculation process ends.

Returning to FIG, 19, if the process at step S101 ends, the process is advanced to step S3. Descriptions of the processes at steps S3 to S15 are omitted since the processes are conducted similarly to those in the first embodiment.

Described next is a process conducted if the current operation state is NOT determined as a touch-off as a result of the determination at step S11 in FIG. 20. In such case, first, at step S102, it is determined whether or not an inertia scrolling is currently being conducted. As a result, if it is determined that an inertia scrolling is currently NOT being conducted (NO at step S102), the process is advanced to step S22.

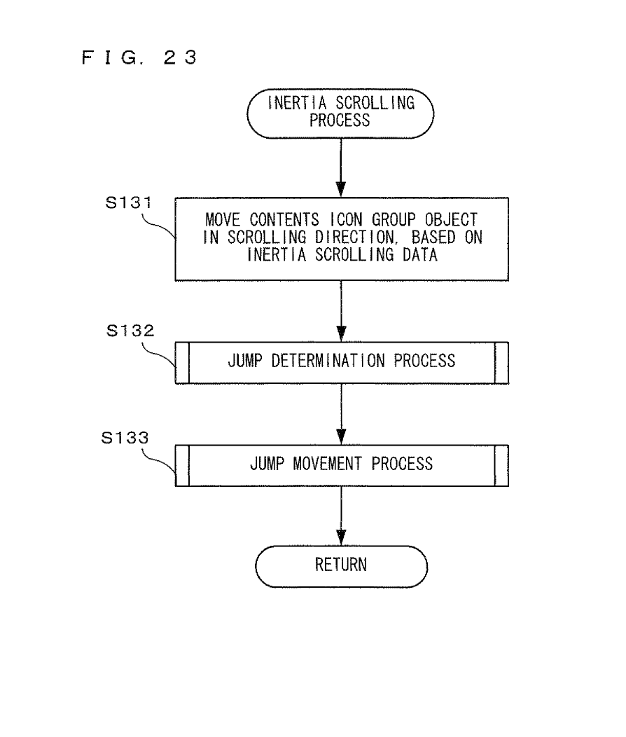

On the other hand, if it is determined that an inertia scrolling is currently being conducted (YES at step S102), at step S103, an inertia scrolling process is executed. FIG. 23 is a flowchart showing details of the inertia scrolling process indicated at step S103. First, at step S131, a process of moving the contents icon group object in a scrolling direction (in this case, a direction along the X-axis) based on the inertia scrolling data 328 (which is calculated by the process at step S15) is conducted (thus, the inertia scrolling is conducted).

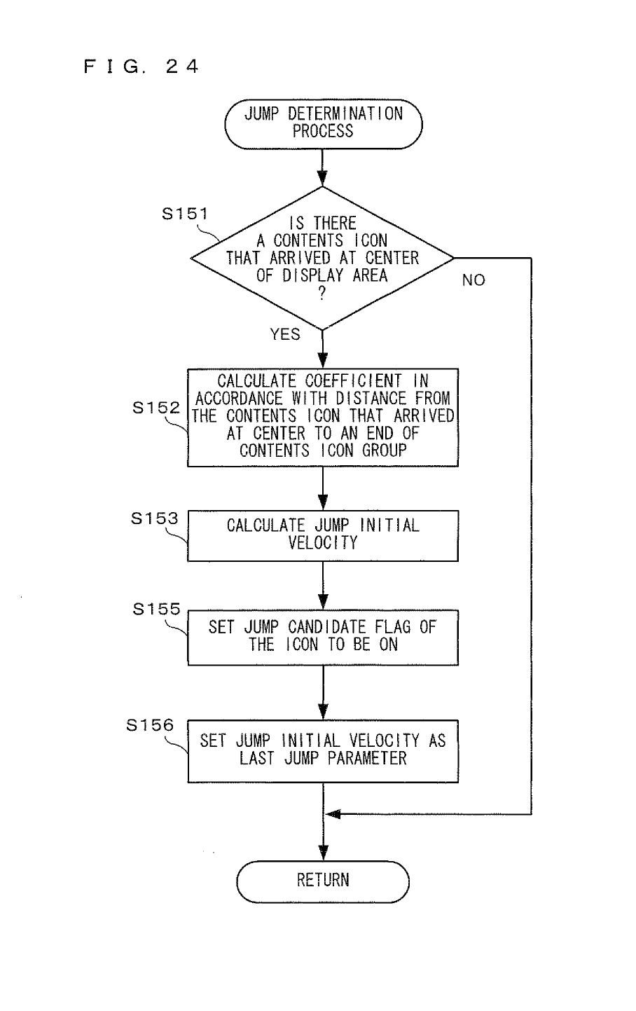

Next, at step S132, a jump determination process is executed. In this process, it is determined whether or not there is a contents icon 101 arriving at the center of the display area resulting from the process at step S131, and if there is one, a process of configuring preparation settings for the jump representation is executed. FIG. 24 is a flowchart showing details of the jump determination process indicated at step S132. First, at step S151, it is determined whether or not there is a contents icon 101 which the middle point thereof has reached the center point of the X-axis of the display area. As a result, if there is NO contents icon that arrived at the center (NO at step S151), the jump determination process ends.

On the other hand, if there is a contents icon that arrived at the center (YES at step S151), at step S152, a distance along the X-axis from the contents icon (the middle point thereof) to an end of the contents icon group is calculated; and coefficient c is calculated in accordance with this distance. Coefficient c is set so as to have a higher value if the contents icon is closer to an end of the contents icon group. For example, if a contents icon that has arrived at the center of the display area is either one of the contents icons located at either end of the contents icon group, coefficient c is set to be “1.0” because of the proximity to an end. Coefficient c is set to be “0.8” if it is a contents icon that is second from an end, and “0.6” if it is a contents icon that is third from an end. Furthermore, if it is a contents icon located at the center of the contents icon group, coefficient c is set to be “0” due to the remoteness from an end. By setting as described above, only a couple of contents icons located near an end of the contents icon group can be made to jump.

Next, at step S153, the jump initial velocity is calculated by using the following formula.

Jump Initial Velocity=tmpV×Coefficient c Formula 4

Thus, a value of the jump initial velocity (and ultimately, the height of the jump) of a contents icon that has arrived at the center of the display area is changed in accordance with a distance from an end of the contents icon group.

Next, at step S155, the jump candidate flag 3254 of the contents icon 101 is set to be ON. Thus, in the second embodiment, each of the contents icons that have arrived at the center of the display area is uniformly set as the jump candidate icon. However, with the processes at steps S152 and S153, a contents icon located far from an end of the contents icon group will not actually jump, since the jump initial velocity is set to “0” or a value close to “0”.

Next, at step S156, the jump initial velocity calculated above is stored as the last jump parameter 3256 for the contents icon that is currently set as a candidate for processing. With this, the jump determination process ends.

Note that, the processes at steps S155 and S156 may not be executed if, for example, the jump initial velocity calculated at step S153 is “0” or a value that is close to “0” and is equal to or smaller than a predetermined value (which means, when a jump is not actually conducted).

Returning to FIG. 23, following the process at step S132, at step S133, a jump movement process is executed. This process is a process to have the jump candidate icon to conduct a jump movement in a direction different from the scrolling direction in order to express the jump representation (in the present embodiment, a direction perpendicular to the scrolling direction). Similarly to that in the first embodiment, the bouncing motion is also included in this jump movement.

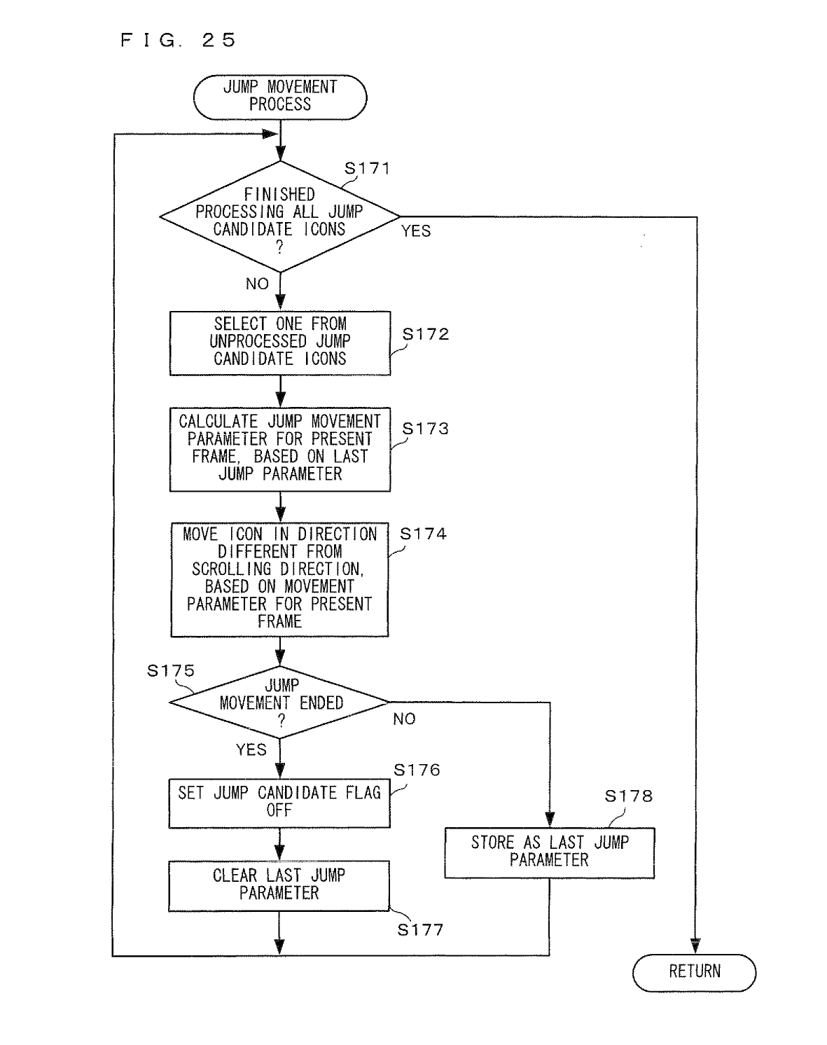

FIG. 25 is a flowchart showing details of the jump movement process indicated at step S133. In FIG. 25, first, at step S171, for all the jump candidate icons (a content icons having the jump candidate flag 3254 thereof set to be ON), it is determined whether or not the processes described in the following have been conducted. As a result, if there is one or more unprocessed jump candidate icons remaining (NO at step S171), at step S172, one of the unprocessed jump candidate icons is selected.

Next, at step S173, various parameters for the jump movement of the jump candidate icon in the present frame is calculated based on the last jump parameter 3256.

Note that, in the present process, since only a value indicating the jump initial velocity is included in the last jump parameter 3256 at the beginning in the first process, based on this value, a movement direction (ascent or descent), an amount of movement, a movement velocity, and the like of the contents icon 101 in the present frame are calculated as parameters for the movement. In the processes following the first process, a jump movement parameter for the last frame is stored as the last jump parameter 3256 in a process at step S178 described later, and therefore, a parameter for the jump movement in the present frame is calculated based on the last jump parameter 3256. In order to move the contents icon 101 so as to bounce, the jump initial velocity is recalculated if necessary as in the first embodiment.

Next, at step S174, the jump candidate icon is moved based on the calculated parameters for the movement.

Next, at step S175, it is determined whether or not the jump movement (the series of movement from the start of the jump to the end of the bouncing that lasts several times) has ended. This is conducted, for example, by determining whether or not the jump initial velocity has become zero after repeatedly recalculating the jump initial velocity in order to bounce the contents icon 101. Furthermore, since a contents icon at a position far from an end of the contents icon group can have the jump initial velocity set to be zero from the beginning, it will be determined that the jump movement has ended for such contents icon without actually conducting the jump movement. As a result of the determination, if it is determined that the jump movement has not been ended (NO at step S175), at step S178, the parameters for the jump movement in the present frame calculated as described above are stored as the last jump parameter 3256. Then, the process returns to step S171, and the processes described above are repeated. On the other hand, if it is determined that the series of jump movements has been ended (YES at step S175), at step S176, the jump candidate flag 3254 for the jump candidate icon that is currently set as a candidate for processing is set to be OFF. Furthermore, at step S177, the last jump parameter 3256 for the jump candidate icon currently set as a candidate for processing is cleared. Then, the process returns to step S171, and the above described processes are repeated.

On the other hand, as a result of the determination at step S171, if it is determined that the above described processes have been conducted for all the jump candidate icons (YES at step S171), the jump movement process ends.

Returning to FIG. 23, if the jump movement process at step S133 ends, the inertia scrolling process also ends.

Returning to FIG. 20, if the inertia scrolling process at step S103 ends, next, the process at step S20 is executed. Descriptions of the processes at steps S20 to S22 are omitted since the processes are similar to those in the first embodiment. With this, the descriptions of the home menu process according to the second embodiment ends.

As described above, in the second embodiment, processes related to the jump representation is conducted every time a contents icon passes through the center of the display area, Furthermore, the height of the jump is determined in accordance with the scrolling velocity and a distance from an end of the contents icon group. Therefore, settings are made such that the faster the scroll velocity is, and the closer a contents icon is located to an end of the contents icon group, the higher the jump will be. As a result, a function similarly to that of the first embodiment, which is to allow the user to intuitively recognize scrolling to an end, is achieved without determining, in every frame, whether or not scrolling has reached an end of the contents icon group as in the first embodiment.

Note that, in the embodiments described above, horizontal scrolling is used as an example, however, the scrolling direction is not limit thereto, and the present invention is also applicable to vertical scrolling. Additionally, the present invention is also applicable to a case where scrolling is possible in both vertical and horizontal directions. Application of the present invention to such a case is conducted by moving (jump representation) the contents icon in a direction different from a scrolling direction that results from a scroll operation. For example, in the case where scrolling is possible in both vertical and horizontal directions: if the user conducts a scroll operation in the vertical direction and the scrolling reaches an end, a motion equivalent to the jump movement may be conducted in the horizontal direction; and if the user conducts a scroll operation in the horizontal direction and the scrolling reaches an end, a motion equivalent to the jump movement may be conducted in the vertical direction.

Furthermore, in the embodiments described above, although the plurality of contents icons 101 in the home screen have been used as an example of the scroll object, the scroll object is not limited thereto. For example, the contents icons 101 have been respectively considered as selection candidates for the user, however, they do not necessarily have to be selection candidates for the user. If what corresponds to the contents icon is merely an image or the like, the image may be a content that allows confirming the property or matter of the content by the appearance thereof (a content only for browsing).

Other than the contents icon 101 as described above, the present invention is also applicable to, for example: a list in which a plurality of items (item objects) are displayed, as in a screen displaying a possession item listing for a game process; thumbnails which are displayed on a screen and which represents images in an image viewer; and the like. In such cases, an item located at an end of the list or the thumbnail screen will be the subject of the jump movement representation described above.

Furthermore, an example other than the scroll objects described above can be one large content (which cannot fit into a single screen) including electronic book contents for an electronic book viewer, an electronic document for an electronic document viewer, and the like. Alternatively, another example can be a browse object (contents including html documents and web pages, which consist of a combination of documents and images) for various browsers such as an internet browser (html browser). In such cases, the contents themselves may be moved so to jump in a direction different from a scrolling direction that results from a scroll operation.

Furthermore, with regard to the above described jump representation, the height of a jump may be set based on a movement history of the contents icon that has arrived at the center of the display area. For example, the amount of movement of the contents icon until it reaches the center of the display area may be calculated, and if the amount of movement after the beginning of the inertia scrolling before arriving to the center is large, the jump may be set and controlled to be higher.

Furthermore, in the embodiments described above, the contents icon jumps when a scrolling reaches an end, however, instead of the having the contents icon to jump, the virtual camera may be moved in the Z-axis direction so as to approach the contents icon. Which means, when the scrolling reaches an end, a representation is conducted such that the contents icon will be view by the user as being scaled up.

Still further, information (indicator) indicating a position of the currently displayed contents icon with regard to the contents icon group may be displayed on an area other than the display area of the contents icon. Thus, such an indicator and the jump representation may coexist. The user can recognize that the scrolling has reached an end by seeing the indicator or seeing the jump of the contents icon. As a result, usability for the user can be enhanced.

Furthermore, in the second embodiment, the center of the display area is use as the predetermined position for conducting the jump determination, however, the predetermined position may be changed every time the contents icon jumps. In this case, the range in which the position changes is preferably in proximity of the predetermined position used as a standard (when applied to the second embodiment, the center of the display area is set as a standard predetermined position, and the predetermined position shifts in the vicinity of the center).

Furthermore, in the second embodiment, the contents icon jumps as soon as it reaches the center of the display area, however, the contents icon may jump after a certain number of frames has past subsequent to reaching the center of the display area, or the contents icon may jump after a certain number of frame has past subsequent to reaching a predetermined position short of the center of the display area (a position away from the center of the display area for a predetermined distance in a direction opposite of the scrolling direction).

Furthermore, in the embodiments described above, described mainly as an example is an operation on a menu screen of a hand-held game apparatus capable of a touch operation. However, the applicable apparatus of the present invention is not limit thereto, and the present invention is also applicable when scrolling contents by conducting the drag operation as described above by using a pointing device on various information processing terminals such as a stationary game apparatus, a personal computer, an electronic book reader, and the like. Other than the touch panel described above, the pointing device may be, for example: a mouse capable of pointing an arbitrary position on a screen, a tablet which is without a display screen and which is for instructing an arbitrary position on an operation surface; and a pointing device that calculates coordinates which are on a display screen and which correspond to a pointed position instructed on a display screen, the coordinates being calculated by using a position of the display screen and a marker within an image taken by pointing a device in a direction of the display screen, the device including imaging means for remotely imaging the display screen, markers arranged in the periphery of the display screen, and the like.

Furthermore, in the embodiments described above, as an example of a device for detecting a position pointed by a player in an operation area when conducting the scroll operation, the touch panel is used; however, a so-called pointing device which allows the player to instruct a position within a predetermined area may be used including examples such as: a mouse capable of pointing an arbitrary position on a screen, a tablet which is without a display screen and which is for instructing an arbitrary position on an operation surface; and a pointing device that calculates coordinates which are on a display screen and which correspond to a pointed position instructed on a display screen, the coordinates being calculated by using a position of the display screen and a marker within an image taken by pointing a device in a direction of the display screen, the device including imaging means for remotely imaging the display screen, markers arranged in the periphery of the display screen, and the like. Furthermore, instead of the pointing device, present invention is also applicable when conducting the scrolling as described above by an operation using a button such as, for example, a cross key, a cursor key, and the like. When such an operation using a button is conducted, for example, when a scroll operation is performed by holding down the left button of a cross key and when the left button is continuously held down, the scroll velocity gradually increases (if holding down the button is stopped in mid-course, a process equivalent to the inertia scrolling may be conducted based on the scroll velocity up to the point), and the above described jump representation is conducted when contents reaches an end.

Furthermore, in the embodiments described above, a case has been described where a series of processes for conducting the jump representation in accordance with the scroll operation are executed on a single apparatus (the game apparatus 1). However, in another embodiment, the series of processes may be executed on an information processing system including a plurality of information processing apparatuses. For example, in an information processing system which includes a terminal side apparatus and a server side apparatus that is capable of communicating with the terminal side apparatus via a network, one part of the processes among the series of processes may be executed on the server side apparatus. Further, in an information processing system which includes a terminal side apparatus and a server side apparatus that is capable of communicating with the terminal side apparatus via a network, main processes of the series of processes may be executed on the server side apparatus, and one part of the processes may be executed on the terminal side apparatus. Still further, in the information processing system described above, the system on the server side may be configured with a plurality of information processing apparatuses, and processes to be executed on the server side may be divided to be executed by the plurality of information processing apparatuses.

While the invention has been described in detail, the foregoing description is in all aspects illustrative and not restrictive. It will be understood that numerous other modifications and variations can be devised without departing from the scope of the invention.

What is claimed is:

1. A computer-readable storage medium having stored thereon a display control program executed by a computer of a display control apparatus which displays, on a display device, a selection object selected in accordance with an operation by a user, the display control program causing the computer to operate as:
first movement control means for moving, relative to a display area of the display device, a plurality of selection objects having at least one part thereof displayed on the display area, based on an output signal outputted from an input device; and
second movement control means for moving, relative to the display area, in a direction different from a direction in which the plurality of selection objects have been moved by the first movement control means, when an end-located selection object among the plurality of selection objects reaches a predetermined position on the display area as a result of the first movement control means moving the plurality of selection objects, at least one selection object displayed on the display area among the plurality of selection objects.

2. The computer-readable storage medium having stored thereon the display control program according to claim 1, wherein the second movement control means moves, among the plurality of selection objects, the end-located selection object and at least one other selection object located in the vicinity of the end-located selection object.

3. The computer-readable storage medium having stored thereon the display control program according to claim 2, wherein the second movement control means moves at least the selection objects displayed on the display area such that each of the selection objects has a different movement distance.

4. The computer-readable storage medium having stored thereon the display control program according to claim 3, wherein the second movement control means moves at least the selection objects displayed on the display area such that a selection object located closer to the end is moved for a larger distance.

5. The computer-readable storage medium having stored thereon the display control program according to claim 1, wherein
the computer is further caused to operate as movement distance determination means for determining a movement distance for which the at least one selection object is moved by the second movement control means, based on a movement velocity at which the end-located selection object is moved by the first movement control means when reaching the predetermined position on the display area; and
the second movement control means moves the at least one selection object for the movement distance determined by the movement distance determination means.

6. The computer-readable storage medium having stored thereon the display control program according to claim 1, wherein the second movement control means moves the at least one selection object in a direction approximately perpendicular to the direction of the movement by the first movement control means.

7. The computer-readable storage medium having stored thereon the display control program according to claim 1, wherein the computer is further caused to operate as restoration means for returning the at least one selection object moved by the second movement control means to a position at which the at least one selection object has been located before the movement.

8. A computer-readable storage medium having stored thereon a display control program executed by a computer of a display control apparatus which displays, on a display device, a selection object selected in accordance with an operation by a user, the display control program causing the computer to operate as:
first movement control means for moving, relative to a display area of the display device, a plurality of selection objects having at least one part thereof displayed on the display area, based on an output signal outputted from an input device; and
second movement control means for moving, relative to the display area, in a direction different from a direction in which the plurality of selection objects have been moved by the first movement control means, when each the plurality of selection objects reaches a predetermined position on the display area as a result of the first movement control means moving the plurality of selection objects, a selection object that has reached the predetermined position.

9. The computer-readable storage medium having stored thereon the display control program according to claim 8, wherein
the computer is further caused to operate as movement distance determination means for determining a movement distance for which the selection object is moved by the second movement control means, based on a movement velocity at which the selection object is moved by the first movement control means when reaching the predetermined position on the display area; and
the second movement control means moves the selection object that has reached the predetermined position on the display area for the movement distance determined by the movement distance determination means.

10. The computer-readable storage medium having stored thereon the display control program according to claim 9, wherein the movement distance determination means determines the movement distance based on the movement velocity at which the selection object is moved by the first movement control means when reaching the predetermined position on the display area, and on a parameter regarding a movement by the first movement control means in the past.

11. The computer-readable storage medium having stored thereon the display control program according to claim 10, wherein the movement distance determination means determines the movement distance such that the movement distance for which the selection object is moved by the second movement control means becomes larger as a distance for which the selection object has been moved in the past by the first movement control means becomes longer.

12. The computer-readable storage medium having stored thereon the display control program according to claim 8, wherein
the computer is further caused to operate as movement distance determination means for determining, when the selection object reaches the predetermined position on the display area, a movement distance for which the selection object is moved by the second movement control means, based on a distance from an endmost position of the plurality of selection objects to the selection object that has reached the predetermined position on the display area; and
the second movement control means moves the selection object that has reached the predetermined position on the display area for the movement distance determined by the movement distance determination means.

13. The computer-readable storage medium having stored thereon the display control program according to claim 12, wherein the movement distance determination means determines the movement distance such that the movement distance becomes larger as a distance from an endmost position of the plurality of selection objects to the selection object that has reached the predetermined position on the display area becomes smaller.

14. The computer-readable storage medium having stored thereon the display control program according to claim 8, wherein
the computer is further caused to operate as movement distance determination means for determining a movement distance for which the selection object is moved by the second movement control means, based on a movement velocity at which the selection object is moved by the first movement control means when reaching the predetermined position on the display area, and on a distance from an endmost position of the plurality of selection objects to the selection object that has reached the predetermined position on the display area; and
the second movement control means moves the selection object that has reached the predetermined position on the display area for the movement distance determined by the movement distance determination means.

15. A computer-readable storage medium having stored thereon a display control program executed by a computer of a display control apparatus which displays a content on a display device, the display control program causing the computer to operate as:
first movement control means for moving, relative to a display area of the display device, a plurality of contents having at least one part thereof displayed on the display area, based on an output signal outputted from an input device; and
second movement control means for moving, relative to the display area, in a direction different from a direction in which the plurality of contents have been moved by the first movement control means, when an end-located content among the plurality of contents reaches a predetermined position on the display area as a result of the first movement control means moving the plurality of contents, at least one content displayed on the display area.

16. A computer-readable storage medium having stored thereon a display control program executed by a computer of a display control apparatus which displays, on a display device, a movement candidate having a size that is undisplayable in a single screen, the display control program causing the computer to operate as:
first movement control means for moving, relative to a display area of the display device, the movement candidate having at least one part thereof displayed on the display area, based on an output signal outputted from an input device; and
second movement control means for moving the movement candidate relative to the display area in a direction different from a direction in which the movement candidate has been moved by the first movement control means, when an end of the movement candidate reaches a predetermined position on the display area as a result of the first movement control means moving the movement candidate.

17. A computer-readable storage medium having stored thereon a display control program executed by a computer of a display control apparatus which displays, on a display device, a list including a plurality of item objects, the display control program causing the computer to operate as:
first movement control means for moving, relative to a display area of the display device, the list having at least one part thereof displayed on the display area, based on an output signal outputted from an input device; and
second movement control means for moving, relative to the display area, in a direction different from a direction in which the list including the plurality of item objects has been moved by the first movement control means, when an item object located at an end of the list is moved by the first movement control means and reaches a predetermined position on the display area, at least one item object displayed on the display area among the list.

18. A computer-readable storage medium having stored thereon a display control program executed by a computer of a display control apparatus which displays, on a display device, a selection object selected in accordance with an operation by a user, the display control program causing the computer to operate as:
first movement control means for moving, relative to a display area of the display device, a plurality of selection objects having at least one part thereof displayed on the display area, based on an output signal outputted from an input device; and
second movement control means for moving, relative to the display area, in a direction different from a direction in which the plurality of selection objects have been moved by the first movement control means, when or immediately before a selection object, which is located at an end in a direction opposite of the direction of the movement by the first movement control means and which is among the plurality of selection objects moved by the first movement control means, reaches a predetermined position on the display area, at least the selection object located at the end.

19. A display control apparatus which displays, on a display device, a selection object selected in accordance with an operation by a user, the display control apparatus comprising:
a first movement control section for moving, relative to a display area of the display device, a plurality of selection objects having at least one part thereof displayed on the display area, based on an output signal outputted from an input device; and
a second movement control section for moving, relative to the display area, in a direction different from a direction in which the plurality of selection objects have been moved by the first movement control section, when an end-located selection object among the plurality of selection objects reaches a predetermined position on the display area as a result of the first movement control section moving the plurality of selection objects, at least one selection object displayed on the display area among the plurality of selection objects.

20. A display control system which displays, on a display device, a selection object selected in accordance with an operation by a user, the display control system comprising:
a first movement control section for moving, relative to a display area of the display device, a plurality of selection objects having at least one part thereof displayed on the display area, based on an output signal outputted from an input device; and
a second movement control section for moving, relative to the display area, in a direction different from a direction in which the plurality of selection objects have been moved by the first movement control section, when an end-located selection object among the plurality of selection objects reaches a predetermined position on the display area as a result of the first movement control section moving the plurality of selection objects, at least one selection object displayed on the display area among the plurality of selection objects.

21. A display control method for displaying, on a display device, a selection object selected in accordance with an operation by a user, the display control method comprising:
a first movement control step of moving, relative to a display area of the display device, a plurality of selection objects having at least one part thereof displayed on the display area, based on an output signal outputted from an input device; and
a second movement control step of moving, relative to the display area, in a direction different from a direction in which the plurality of selection objects have been moved at the first movement control step, when an end-located selection object among the plurality of selection objects reaches a predetermined position on the display area as a result of the first movement control step of moving the plurality of selection objects, at least one selection object displayed on the display area among the plurality of selection objects.
